(19) United States
(12) Patent Application Publication
(10) Pub. No.: US 2013/0194295 A1
(43) Pub. Date: Aug. 1, 2013

(54) SYSTEM AND METHOD FOR CHOOSING DISPLAY MODES

(71) Applicants: Leslie C. Chan, San Diego, CA (US); Ben Lian, San Diego, CA (US); Manish Kothari, Cupertino, CA (US)

(72) Inventors: Leslie C. Chan, San Diego, CA (US); Ben Lian, San Diego, CA (US); Manish Kothari, Cupertino, CA (US)

(73) Assignee: QUALCOMM MEMS TECHNOLOGIES, INC., San Diego, CA (US)

(21) Appl. No.: 13/589,996

(22) Filed: Aug. 20, 2012

Related U.S. Application Data
(60) Provisional application No. 61/591,795, filed on Jan. 27, 2012.

(51) Int. Cl. G09G 5/00

(52) U.S. Cl. 345/619; 345/204

(57) ABSTRACT

This disclosure provides apparatus, systems, and methods for updating display devices. In one aspect, a display can switch between a plurality of display modes based at least in part on a spatial distribution of changed image regions over a number of frames of an image to be displayed.

### RELATED APPLICATIONS

This application claims priority to U.S. Provisional Application Ser. No. 61/591,795 filed Jan. 27, 2012, entitled “SYSTEM AND METHOD FOR CHOOSING DISPLAY MODES,” which is hereby incorporated by reference herein for all purposes.

### TECHNICAL FIELD

This disclosure relates to modes of updating a display apparatus.

### DESCRIPTION OF THE RELATED TECHNOLOGY

Electromechanical systems include devices having electrical and mechanical elements, actuators, transducers, sensors, optical components (e.g., mirrors) and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers, or that add layers to form electrical and electromechanical devices.

One type of electromechanical systems device is called an interferometric modulator (IMOD). As used herein, the term interferometric modulator or interferometric light modulator refers to a device that selectively absorbs and/or reflects light using the principles of optical interference. In some implementations, an interferometric modulator may include a pair of conductive plates, one or both of which may be transparent and/or reflective, wholly or in part, and capable of relative motion upon application of an appropriate electrical signal. In an implementation, one plate may include a stationary layer deposited on a substrate and the other plate may include a reflective membrane separated from the stationary layer by an air gap. The position of one plate in relation to another can change the optical interference of light incident on the interferometric modulator. Interferometric modulator devices have a wide range of applications, and are anticipated to be used in improving existing products and creating new products, especially those with display capabilities.

### SUMMARY

The systems, methods and devices of the disclosure each have several innovative aspects, no single one of which is solely responsible for the desirable attributes disclosed herein.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

In some implementations, an apparatus comprising a processor for driving a display including a plurality of common lines is disclosed. The processor can be configured to obtain image data to be displayed for a plurality of frames, wherein the image data includes a plurality of image regions. The processor can further be configured to select a display mode from a plurality of display modes based at least in part on a spatial distribution of changed image regions over the plurality of frames. The processor can also be configured to update the display according to the selected display mode.

In some implementations, a method of updating a display having a plurality of common lines is disclosed. The method can comprise obtaining image data to be displayed, and detecting an amount of change of image data for a plurality of image regions over a plurality of frames to be displayed. The method can further comprise comparing the amount of change for each image region to a threshold to determine whether each image region is a changed image region. In some implementations, the method includes selecting a display mode from a plurality of display modes based at least in part on a spatial distribution of changed image regions over the plurality of frames; and, can include updating the display according to the selected display mode.

In other implementations, a system for selecting display modes in a display is disclosed. The system can comprise means for obtaining image data to be displayed, and means for detecting an amount of change of image data for a plurality of image regions over a plurality of frames to be displayed. In some implementations, the system can further include means for comparing the amount of change for each image region to a threshold to determine whether each image region is a changed image region, and means for selecting a display mode from a plurality of display modes based at least in part on a spatial distribution of changed image regions over the plurality of frames. The system can further include means for updating the display according to the selected mode.

In yet other implementations, a computer program product for processing data for a program configured to drive a display is disclosed. The computer program product can comprise a non-transitory computer-readable medium having stored thereon code for causing processing circuitry to obtain image data to be displayed for a plurality of frames. The code can also cause the processing circuitry to select a display mode from a plurality of display modes based at least in part on a spatial distribution of changed image regions over the plurality of frames, and to update the display according to the selected display mode.

In some implementations, a module for switching between high and low resolution modes in a display is disclosed. The module can include circuitry configured to switch a display mode of a display from a high resolution mode to a low resolution mode when image data for a plurality of successive frames substantially changes in substantially distributed portions of the frames. The circuitry can also be configured to switch the display mode of the display from the low resolution mode to the high resolution mode when image data for the plurality of successive frames does not substantially change or substantially changes in substantially localized portions of the frames.

### BRIEF DESCRIPTION OF THE DRAWINGS

FIG. 1 shows an example of an isometric view depicting two adjacent pixels in a series of pixels of an interferometric modulator (IMOD) display device.

FIG. 2 shows an example of a system block diagram illustrating an electronic device incorporating a 3×3 interferometric modulator display.

FIG. 3 shows an example of a diagram illustrating movable reflective layer position versus applied voltage for the interferometric modulator of FIG. 1.

FIG. 4 shows an example of a table illustrating various states of an interferometric modulator when various common and segment voltages are applied.

FIG. 5A shows an example of a diagram illustrating a frame of display data in the 3×3 interferometric modulator display of FIG. 2.

FIG. 5B shows an example of a timing diagram for common and segment signals that may be used to write the frame of display data illustrated in FIG. 5A.

FIG. 6A shows an example of a partial cross-section of the interferometric modulator display of FIG. 1.

FIGS. 6B-6E show examples of cross-sections of varying implementations of interferometric modulators.

FIG. 7 shows an example of a flow diagram illustrating a manufacturing process for an interferometric modulator.

FIGS. 8A-8E show examples of cross-sectional schematic illustrations of various stages in a method of making an interferometric modulator.

FIG. 9 schematically illustrates an example of an array of display elements including a plurality of common lines and a plurality of segment lines.

FIG. 10 is a flowchart illustrating an example process for writing a portion of a frame using a line multiplying process.

FIG. 11 is a flowchart illustrating an example process for writing monochrome image data to at least a portion of a color display.

FIG. 12 is a flowchart illustrating an example process for updating a display according to a multi-line addressing mode, where the selection of the multi-line addressing mode is based, at least in part on the data to be displayed.

FIG. 13 is a flowchart illustrating a method of selecting a single or multi-line addressing mode based at least in part on an amount of change in image data to be displayed.

FIG. 14 shows an example block diagram illustrating one implementation of a system for selecting display modes in a display.

FIG. 15 is a flowchart illustrating a method of selecting a high or low resolution mode based at least in part on a spatial distribution of changed image regions.

FIGS. 16A, 16B and 16D are flowcharts illustrating various methods of switching between high and low resolution modes in a display.

FIGS. 16C and 16E illustrate various regions of a display useful in determining a distribution of changed image regions.

FIGS. 17A-C schematically illustrate a frame having a grid of image regions at predefined coordinates according to one implementation.

FIGS. 18A-C schematically illustrate example images that can be displayed according to some implementations.

FIGS. 19A and 19B show examples of system block diagrams illustrating a display device that includes a plurality of interferometric modulators.

Like reference numbers and designations in the various drawings indicate like elements.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, tablets, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes, and electronic test equipment. Thus, the teachings are not intended to be limited to the implementations depicted solely in the Figures, but instead have wide applicability as will be readily apparent to a person having ordinary skill in the art.

Displaying data on MEMS display devices raises several considerations, including power consumption and user experience. MEMS devices are often used in portable electronic devices for which conserving battery power is important. Likewise, MEMS devices may suffer from low refresh rates which degrades user experience when displaying some types of data (e.g., video). Systems and methods are described herein which are configured to determine how to update a display based at least in part on changes in frames of data to be displayed, resulting in increased power efficiency, maintenance of user experience, or both. In particular, systems and methods for determining when to update a display according to different display update modes are presented.

Particular implementations of the subject matter described in this disclosure can be implemented to realize one or more of the following potential advantages. First, power consumption by displays may be reduced. Second, the display mode that corresponds to a desirable user experience may be selected and used to update the display.

An example of a suitable MEMS device, to which the described implementations may apply, is a reflective display device. Reflective display devices can incorporate interferometric modulators (IMODs) to selectively absorb and/or reflect light incident thereon using principles of optical interference. IMODs can include an absorber, a reflector that is movable with respect to the absorber, and an optical resonant cavity defined between the absorber and the reflector. The reflector can be moved to two or more different positions, which can change the size of the optical resonant cavity and thereby affect the reflectance of the interferometric modulator. The reflectance spectrums of IMODs can create fairly broad spectral bands which can be shifted across the visible wavelengths to generate different colors. The position of the spectral band can be adjusted by changing the thickness of the optical resonant cavity, i.e., by changing the position of the reflector.

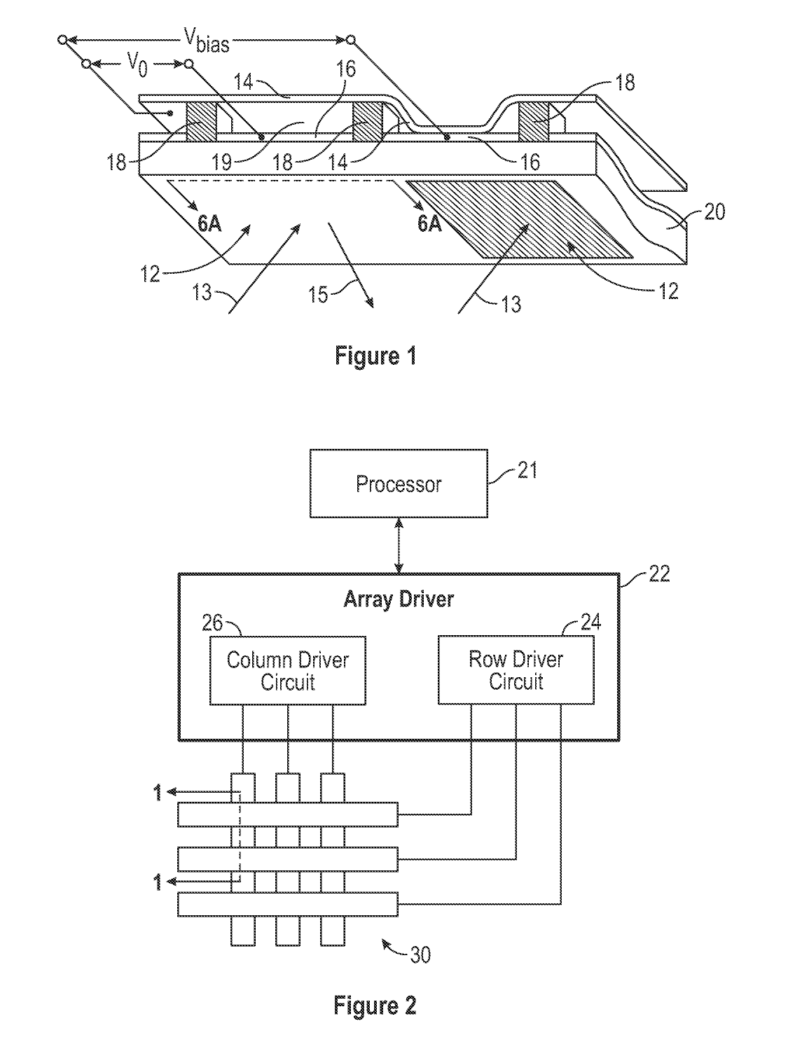

FIG. 1 shows an example of an isometric view depicting two adjacent pixels in a series of pixels of an interferometric modulator (IMOD) display device. The IMOD display device includes one or more interferometric MEMS display elements. In these devices, the pixels of the MEMS display elements can be in either a bright or dark state. In the bright (“relaxed,” “open” or “on”) state, the display element reflects a large portion of incident visible light, e.g., to a user. Conversely, in the dark (“actuated,” “closed” or “off”) state, the display element reflects little incident visible light. In some implementations, the light reflectance properties of the on and off states may be reversed. MEMS pixels can be configured to reflect predominantly at particular wavelengths allowing for a color display in addition to black and white.

The IMOD display device can include a row/column array of IMODs. Each IMOD can include a pair of reflective layers, i.e., a movable reflective layer and a fixed partially reflective layer, positioned at a variable and controllable distance from each other to form an air gap (also referred to as an optical gap or cavity). The movable reflective layer may be moved between at least two positions. In a first position, i.e., a relaxed position, the movable reflective layer can be positioned at a relatively large distance from the fixed partially reflective layer. In a second position, i.e., an actuated position, the movable reflective layer can be positioned more closely to the partially reflective layer. Incident light that reflects from the two layers can interfere constructively or destructively depending on the position of the movable reflective layer, producing either an overall reflective or non-reflective state for each pixel. In some implementations, the IMOD may be in a reflective state when unactuated, reflecting light within the visible spectrum, and may be in a dark state when unactuated, reflecting light outside of the visible range (e.g., infrared light). In some other implementations, however, an IMOD may be in a dark state when unactuated, and in a reflective state when actuated. In some implementations, the introduction of an applied voltage can drive the pixels to change states. In some other implementations, an applied charge can drive the pixels to change states.

The depicted portion of the pixel array in FIG. 1 includes two adjacent interferometric modulators 12. In the IMOD 12 on the left (as illustrated), a movable reflective layer 14 is illustrated in a relaxed position at a predetermined distance from an optical stack 16, which includes a partially reflective layer. The voltage V₀ applied across the IMOD 12 on the left is insufficient to cause actuation of the movable reflective layer 14. In the IMOD 12 on the right, the movable reflective layer 14 is illustrated in an actuated position near or adjacent the optical stack 16. The voltage V_{bias} applied across the IMOD 12 on the right is sufficient to maintain the movable reflective layer 14 in the actuated position.

In FIG. 1, the reflective properties of pixels 12 are generally illustrated with arrows 13 indicating light incident upon the pixels 12, and light 15 reflecting from the pixel 12 on the left. Although not illustrated in detail, it will be understood by a person having ordinary skill in the art that most of the light 13 incident upon the pixels 12 will be transmitted through the transparent substrate 20, toward the optical stack 16. A portion of the light incident upon the optical stack 16 will be transmitted through the partially reflective layer of the optical stack 16, and a portion will be reflected back through the transparent substrate 20. The portion of light 13 that is transmitted through the optical stack 16 will be reflected at the movable reflective layer 14, back toward (and through) the transparent substrate 20. Interference (constructive or destructive) between the light reflected from the partially reflective layer of the optical stack 16 and the light reflected from the movable reflective layer 14 will determine the wavelength(s) of light 15 reflected from the pixel 12.

The optical stack 16 can include a single layer or several layers. The layer(s) can include one or more of an electrode layer, a partially reflective and partially transmissive layer and a transparent dielectric layer. In some implementations, the optical stack 16 is electrically conductive, partially transparent and partially reflective, and may be fabricated, for example, by depositing one or more of the above layers onto a transparent substrate 20. The electrode layer can be formed from a variety of materials, such as various metals, for example indium tin oxide (ITO). The partially reflective layer can be formed from a variety of materials that are partially reflective, such as various metals, e.g., chromium (Cr), semiconductors, and dielectrics. The partially reflective layer can be formed of one or more layers of materials, and each of the layers can be formed of a single material or a combination of materials. In some implementations, the optical stack 16 can include a single semi-transparent thickness of metal or semiconductor which serves as both an optical absorber and conductor, while different, more conductive layers or portions (e.g., of the optical stack 16 or of other structures of the IMOD) can serve to bus signals between IMOD pixels. The optical stack 16 also can include one or more insulating or dielectric layers covering one or more conductive layers or a conductive/absorptive layer.

In some implementations, the layer(s) of the optical stack 16 can be patterned into parallel strips, and may form row electrodes in a display device as described further below. As will be understood by one having skill in the art, the term “patterned” is used herein to refer to masking as well as etching processes. In some implementations, a highly conductive and reflective material, such as aluminum (Al), may be used for the movable reflective layer 14, and these strips may form column electrodes in a display device. The movable reflective layer 14 may be formed as a series of parallel strips of a deposited metal layer or layers (orthogonal to the row electrodes of the optical stack 16) to form columns deposited on top of posts 18 and an intervening sacrificial material deposited between the posts 18. When the sacrificial material is etched away, a defined gap 19, or optical cavity, can be formed between the movable reflective layer 14 and the optical stack 16. In some implementations, the spacing between posts 18 may be on the order of 1-1000 um, while the gap 19 may be on the order of <10,000 Angstroms (Å).

In some implementations, each pixel of the IMOD, whether in the actuated or relaxed state, is essentially a capacitor formed by the fixed and moving reflective layers. When no voltage is applied, the movable reflective layer 14 remains in a mechanically relaxed state, as illustrated by the pixel 12 on the left in FIG. 1, with the gap 19 between the movable reflective layer 14 and optical stack 16. However, when a potential difference, e.g., voltage, is applied to at least one of a selected row and column, the capacitor formed at the intersection of the row and column electrodes at the corresponding pixel becomes charged, and electrostatic forces pull the electrodes together. If the applied voltage exceeds a threshold, the movable reflective layer 14 can deform and move near or against the optical stack 16. A dielectric layer (not shown) within the optical stack 16 may prevent shorting and control the separation distance between the layers 14 and 16, as illustrated by the actuated pixel 12 on the right in FIG. 1. The behavior is the same regardless of the polarity of the applied potential difference. Though a series of pixels in an array may be referred to in some instances as “rows” or “columns,” a person having ordinary skill in the art will readily understand that referring to one direction as a “row” and another as a “column” is arbitrary. Restated, in some orientations, the rows can be considered columns, and the columns considered to be rows. Furthermore, the display elements may be evenly arranged in orthogonal rows and columns (an “array”), or arranged in non-linear configurations, for example, having certain positional offsets with respect to one another (a “mosaic”). The terms “array” and “mosaic” may refer to either configuration. Thus, although the display is referred to as including an “array” or “mosaic,” the elements themselves need not be arranged orthogonally to one another, or disposed in an even distribution, in any instance, but may include arrangements having asymmetric shapes and unevenly distributed elements.

FIG. 2 shows an example of a system block diagram illustrating an electronic device incorporating a 3×3 interferometric modulator display. The electronic device includes a processor 21 that may be configured to execute one or more software modules. In addition to executing an operating system, the processor 21 may be configured to execute one or more software applications, including a web browser, a telephone application, an email program, or any other software application.

The processor 21 can be configured to communicate with an array driver 22. The array driver 22 can include a row driver circuit 24 and a column driver circuit 26 that provide signals to, e.g., a display array or panel 30. The cross section of the IMOD display device illustrated in FIG. 1 is shown by the lines 1-1 in FIG. 2. Although FIG. 2 illustrates a 3×3 array of IMODs for the sake of clarity, the display array 30 may contain a very large number of IMODs, and may have a different number of IMODs in rows than in columns, and vice versa.

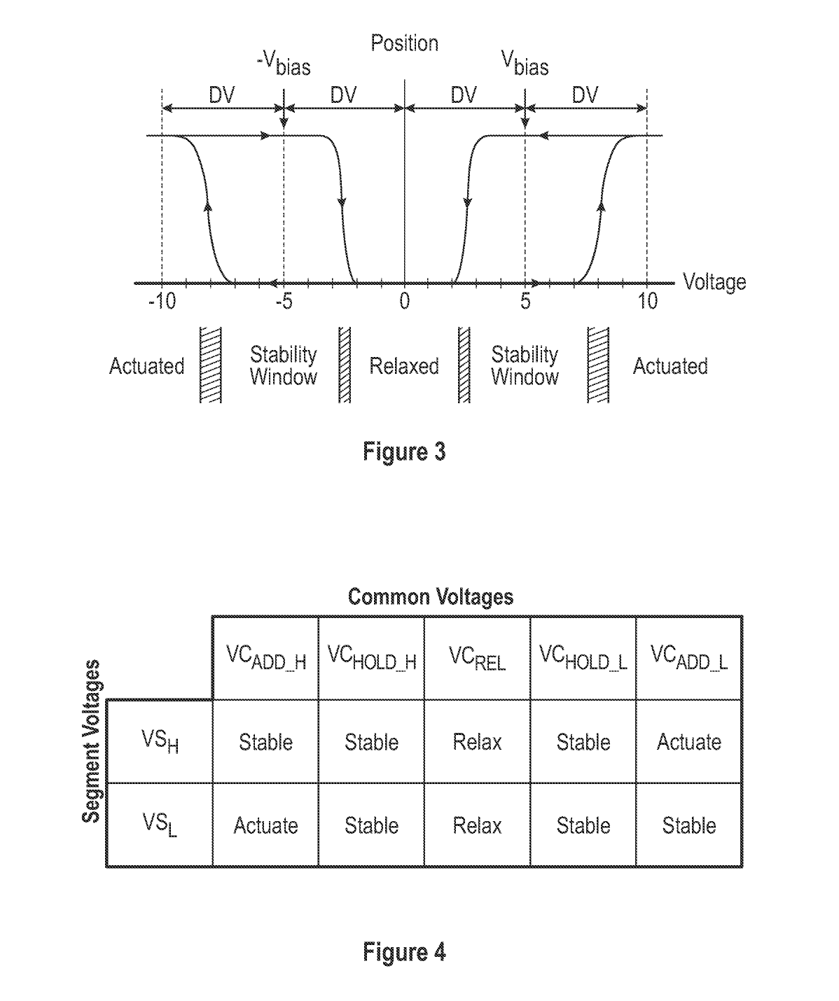

FIG. 3 shows an example of a diagram illustrating movable reflective layer position versus applied voltage for the interferometric modulator of FIG. 1. For MEMS interferometric modulators, the row/column (i.e., common/segment) write procedure may take advantage of a hysteresis property of these devices as illustrated in FIG. 3. An interferometric modulator may require, for example, about a 10-volt potential difference to cause the movable reflective layer, or mirror, to change from the relaxed state to the actuated state. When the voltage is reduced from that value, the movable reflective layer maintains its state as the voltage drops back below, e.g., 10-volts, however, the movable reflective layer does not relax completely until the voltage drops below 2-volts. Thus, a range of voltage, approximately 3 to 7-volts, as shown in FIG. 3, exists where there is a window of applied voltage within which the device is stable in either the relaxed or actuated state. This is referred to herein as the “hysteresis window” or “stability window.” For a display array 30 having the hysteresis characteristics of FIG. 3, the row/column write procedure can be designed to address one or more rows at a time, such that during the addressing of a given row, pixels in the addressed row that are to be actuated are exposed to a voltage difference of about 10-volts, and pixels that are to be relaxed are exposed to a voltage difference of near zero volts. After addressing, the pixels are exposed to a steady state or bias voltage difference of approximately 5-volts such that they remain in the previous strobing state. In this example, after being addressed, each pixel sees a potential difference within the “stability window” of about 3-7-volts. This hysteresis property feature enables the pixel design, e.g., illustrated in FIG. 1, to remain stable in either an actuated or relaxed pre-existing state under the same applied voltage conditions. Since each IMOD pixel, whether in the actuated or relaxed state, is essentially a capacitor formed by the fixed and moving reflective layers, this stable state can be held at a steady voltage within the hysteresis window without substantially consuming or losing power. Moreover, essentially little or no current flows into the IMOD pixel if the applied voltage potential remains substantially fixed.

In some implementations, a frame of an image may be created by applying data signals in the form of “segment” voltages along the set of column electrodes, in accordance with the desired change (if any) to the state of the pixels in a given row. Each row of the array can be addressed in turn, such that the frame is written one row at a time. To write the desired data to the pixels in a first row, segment voltages corresponding to the desired state of the pixels in the first row can be applied on the column electrodes, and a first row pulse in the form of a specific “common” voltage or signal can be applied to the first row electrode. The set of segment voltages can then be changed to correspond to the desired change (if any) to the state of the pixels in the second row, and a second common voltage can be applied to the second row electrode. In some implementations, the pixels in the first row are unaffected by the change in the segment voltages applied along the column electrodes, and remain in the state they were set to during the first common voltage row pulse. This process may be repeated for the entire series of rows, or alternatively, columns, in a sequential fashion to produce the image frame. The frames can be refreshed and/or updated with new image data by continually repeating this process at some desired number of frames per second.

The combination of segment and common signals applied across each pixel (that is, the potential difference across each pixel) determines the resulting state of each pixel. FIG. 4 shows an example of a table illustrating various states of an interferometric modulator when various common and segment voltages are applied. As will be readily understood by one having ordinary skill in the art, the “segment” voltages can be applied to either the column electrodes or the row electrodes, and the “common” voltages can be applied to the other of the column electrodes or the row electrodes.

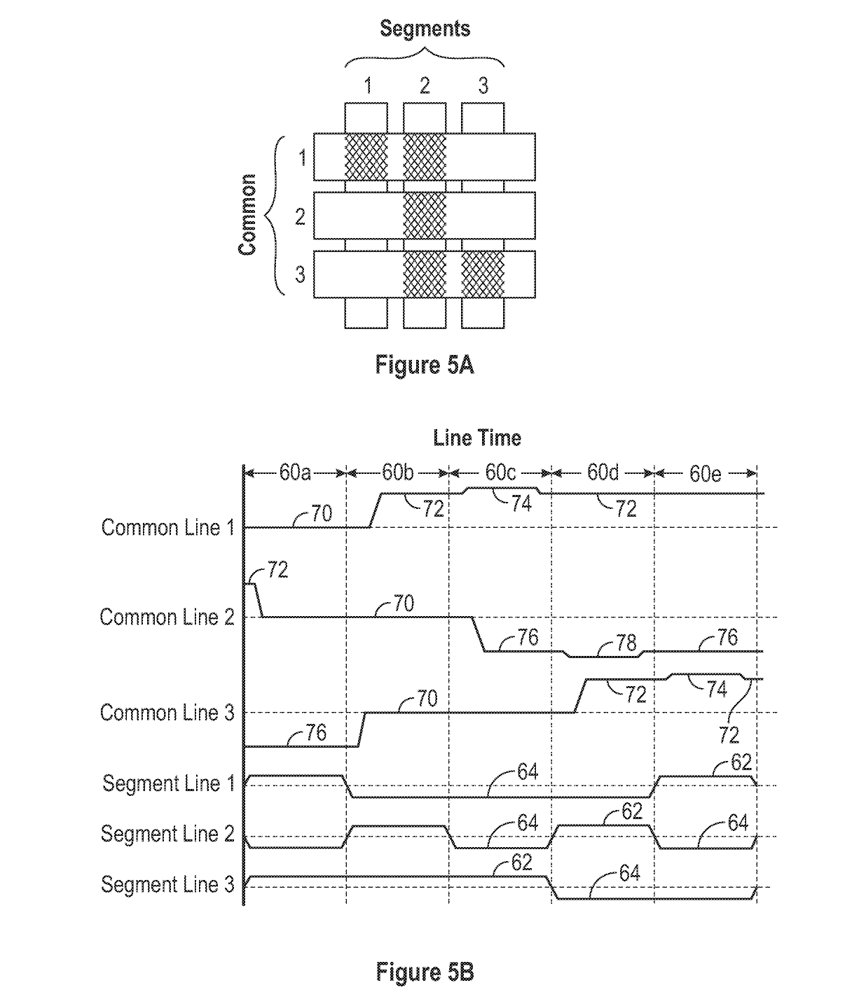

As illustrated in FIG. 4 (as well as in the timing diagram shown in FIG. 5B), when a release voltage VC_{REL} is applied along a common line, all interferometric modulator elements along the common line will be placed in a relaxed state, alternatively referred to as a released or unactuated state, regardless of the voltage applied along the segment lines, i.e., high segment voltage VS_{H} and low segment voltage VS_{L}. In particular, when the release voltage VC_{REL} is applied along a common line, the potential voltage across the modulator (alternatively referred to as a pixel voltage) is within the relaxation window (see FIG. 3, also referred to as a release window) both when the high segment voltage VS_{H} and the low segment voltage VS_{L} are applied along the corresponding segment line for that pixel.

When a hold voltage is applied on a common line, such as a high hold voltage VC_{HOLD}_{_{—}}_{H} or a low hold voltage VC_{HOLD}_{_{—}}_{L}, the state of the interferometric modulator will remain constant. For example, a relaxed IMOD will remain in a relaxed position, and an actuated IMOD will remain in an actuated position. The hold voltages can be selected such that the pixel voltage will remain within a stability window both when the high segment voltage VS_{H} and the low segment voltage VS_{L} are applied along the corresponding segment line. Thus, the segment voltage swing, i.e., the difference between the high VS_{H} and low segment voltage VS_{L}, is less than the width of either the positive or the negative stability window.

When an addressing, or actuation, voltage is applied on a common line, such as a high addressing voltage VC_{ADD}_{_{—}}_{H} or a low addressing voltage VC_{ADD}_{_{—}}_{L}, data can be selectively written to the modulators along that line by application of segment voltages along the respective segment lines. The segment voltages may be selected such that actuation is dependent upon the segment voltage applied. When an addressing voltage is applied along a common line, application of one segment voltage will result in a pixel voltage within a stability window, causing the pixel to remain unactuated. In contrast, application of the other segment voltage will result in a pixel voltage beyond the stability window, resulting in actuation of the pixel. The particular segment voltage which causes actuation can vary depending upon which addressing voltage is used. In some implementations, when the high addressing voltage VC_{ADD}_{_{—}}_{H} is applied along the common line, application of the high segment voltage VS_{H} can cause a modulator to remain in its current position, while application of the low segment voltage VS_{L} can cause actuation of the modulator. As a corollary, the effect of the segment voltages can be the opposite when a low addressing voltage VC_{ADD}_{_{—}}_{L} is applied, with high segment voltage VS_{H} causing actuation of the modulator, and low segment voltage VS_{L} having no effect (i.e., remaining stable) on the state of the modulator.

In some implementations, hold voltages, address voltages, and segment voltages may be used which always produce the same polarity potential difference across the modulators. In some other implementations, signals can be used which alternate the polarity of the potential difference of the modulators. Alternation of the polarity across the modulators (that is, alternation of the polarity of write procedures) may reduce or inhibit charge accumulation which could occur after repeated write operations of a single polarity.

FIG. 5A shows an example of a diagram illustrating a frame of display data in the 3×3 interferometric modulator display of FIG. 2. FIG. 5B shows an example of a timing diagram for common and segment signals that may be used to write the frame of display data illustrated in FIG. 5A. The signals can be applied to the, e.g., 3×3 array of FIG. 2, which will ultimately result in the line time 60e display arrangement illustrated in FIG. 5A. The actuated modulators in FIG. 5A are in a dark-state, i.e., where a substantial portion of the reflected light is outside of the visible spectrum so as to result in a dark appearance to, e.g., a viewer. Prior to writing the frame illustrated in FIG. 5A, the pixels can be in any state, but the write procedure illustrated in the timing diagram of FIG. 5B presumes that each modulator has been released and resides in an unactuated state before the first line time 60a.

During the first line time 60a: a release voltage 70 is applied on common line 1; the voltage applied on common line 2 begins at a high hold voltage 72 and moves to a release voltage 70; and a low hold voltage 76 is applied along common line 3. Thus, the modulators (common 1, segment 1), (1,2) and (1,3) along common line 1 remain in a relaxed, or unactuated, state for the duration of the first line time 60a, the modulators (2,1), (2,2) and (2,3) along common line 2 will move to a relaxed state, and the modulators (3,1), (3,2) and (3,3) along common line 3 will remain in their previous state. With reference to FIG. 4, the segment voltages applied along segment lines 1, 2 and 3 will have no effect on the state of the interferometric modulators, as none of common lines 1, 2 or 3 are being exposed to voltage levels causing actuation during line time 60a (i.e., VC_{REL}—relax and VC_{HOLD}_{_{—}}_{L}—stable).

During the second line time 60b, the voltage on common line 1 moves to a high hold voltage 72, and all modulators along common line 1 remain in a relaxed state regardless of the segment voltage applied because no addressing, or actuation, voltage was applied on the common line 1. The modulators along common line 2 remain in a relaxed state due to the application of the release voltage 70, and the modulators (3,1), (3,2) and (3,3) along common line 3 will relax when the voltage along common line 3 moves to a release voltage 70.

During the third line time 60c, common line 1 is addressed by applying a high address voltage 74 on common line 1. Because a low segment voltage 64 is applied along segment lines 1 and 2 during the application of this address voltage, the pixel voltage across modulators (1,1) and (1,2) is greater than the high end of the positive stability window (i.e., the voltage differential exceeded a predefined threshold) of the modulators, and the modulators (1,1) and (1,2) are actuated. Conversely, because a high segment voltage 62 is applied along segment line 3, the pixel voltage across modulator (1,3) is less than that of modulators (1,1) and (1,2), and remains within the positive stability window of the modulator; modulator (1,3) thus remains relaxed. Also during line time 60c, the voltage along common line 2 decreases to a low hold voltage 76, and the voltage along common line 3 remains at a release voltage 70, leaving the modulators along common lines 2 and 3 in a relaxed position.

During the fourth line time 60d, the voltage on common line 1 returns to a high hold voltage 72, leaving the modulators along common line 1 in their respective addressed states. The voltage on common line 2 is decreased to a low address voltage 78. Because a high segment voltage 62 is applied along segment line 2, the pixel voltage across modulator (2,2) is below the lower end of the negative stability window of the modulator, causing the modulator (2,2) to actuate. Conversely, because a low segment voltage 64 is applied along segment lines 1 and 3, the modulators (2,1) and (2,3) remain in a relaxed position. The voltage on common line 3 increases to a high hold voltage 72, leaving the modulators along common line 3 in a relaxed state.

Finally, during the fifth line time 60e, the voltage on common line 1 remains at high hold voltage 72, and the voltage on common line 2 remains at a low hold voltage 76, leaving the modulators along common lines 1 and 2 in their respective addressed states. The voltage on common line 3 increases to a high address voltage 74 to address the modulators along common line 3. As a low segment voltage 64 is applied on segment lines 2 and 3, the modulators (3,2) and (3,3) actuate, while the high segment voltage 62 applied along segment line 1 causes modulator (3,1) to remain in a relaxed position. Thus, at the end of the fifth line time 60e, the 3×3 pixel array is in the state shown in FIG. 5A, and will remain in that state as long as the hold voltages are applied along the common lines, regardless of variations in the segment voltage which may occur when modulators along other common lines (not shown) are being addressed.

In the timing diagram of FIG. 5B, a given write procedure (i.e., line times 60a-60e) can include the use of either high hold and address voltages, or low hold and address voltages. Once the write procedure has been completed for a given common line (and the common voltage is set to the hold voltage having the same polarity as the actuation voltage), the pixel voltage remains within a given stability window, and does not pass through the relaxation window until a release voltage is applied on that common line. Furthermore, as each modulator is released as part of the write procedure prior to addressing the modulator, the actuation time of a modulator, rather than the release time, may determine the necessary line time. Specifically, in implementations in which the release time of a modulator is greater than the actuation time, the release voltage may be applied for longer than a single line time, as depicted in FIG. 5B. In some other implementations, voltages applied along common lines or segment lines may vary to account for variations in the actuation and release voltages of different modulators, such as modulators of different colors.

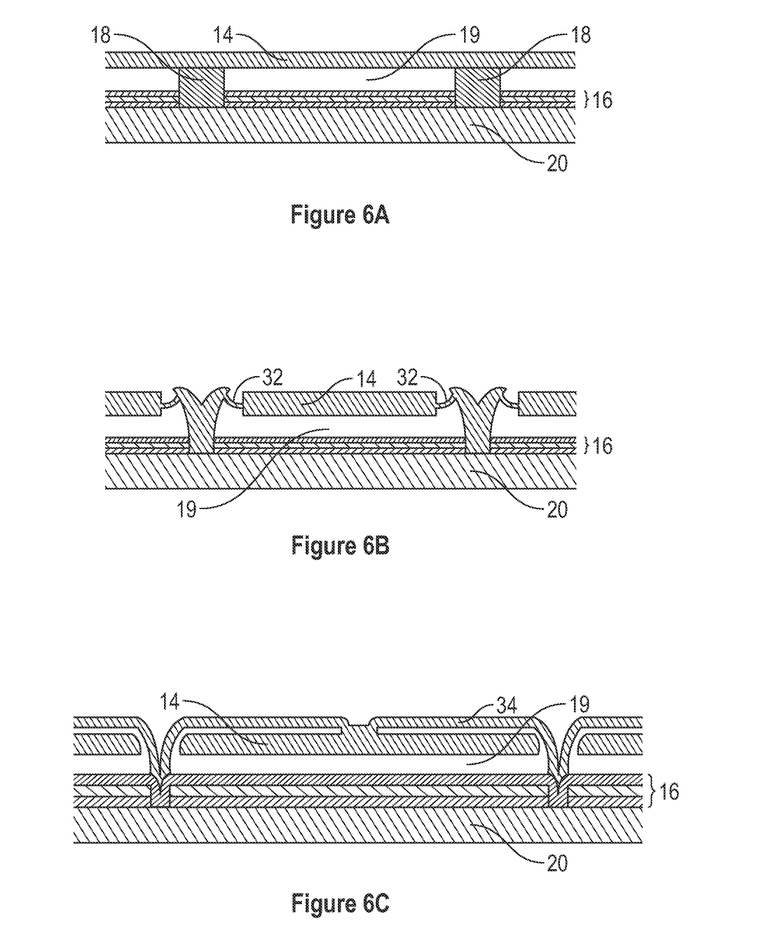

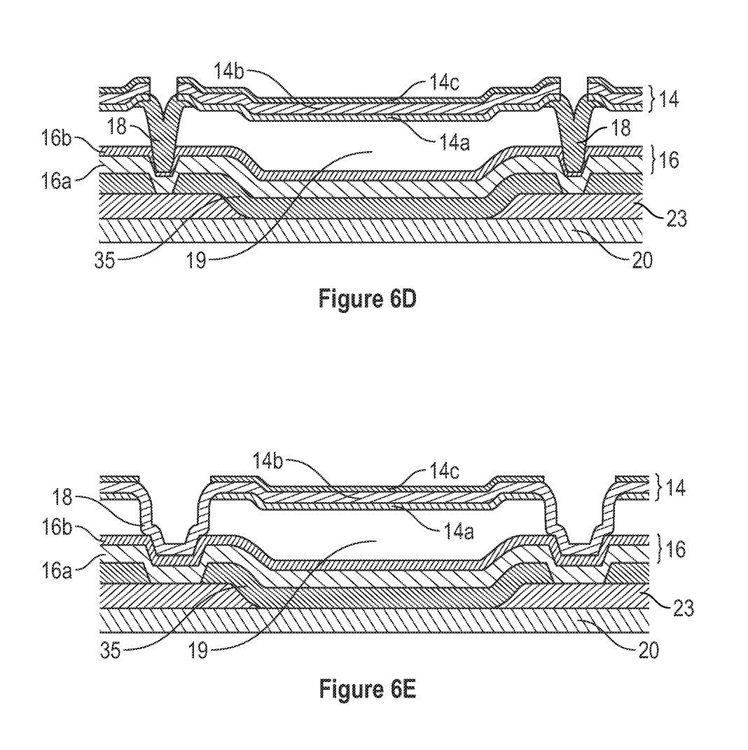

The details of the structure of interferometric modulators that operate in accordance with the principles set forth above may vary widely. For example, FIGS. 6A-6E show examples of cross-sections of varying implementations of interferometric modulators, including the movable reflective layer 14 and its supporting structures. FIG. 6A shows an example of a partial cross-section of the interferometric modulator display of FIG. 1, where a strip of metal material, i.e., the movable reflective layer 14 is deposited on supports 18 extending orthogonally from the substrate 20. In FIG. 6B, the movable reflective layer 14 of each IMOD is generally square or rectangular in shape and attached to supports at or near the corners, on tethers 32. In FIG. 6C, the movable reflective layer 14 is generally square or rectangular in shape and suspended from a deformable layer 34, which may include a flexible metal. The deformable layer 34 can connect, directly or indirectly, to the substrate 20 around the perimeter of the movable reflective layer 14. These connections are herein referred to as support posts. The implementation shown in FIG. 6C has additional benefits deriving from the decoupling of the optical functions of the movable reflective layer 14 from its mechanical functions, which are carried out by the deformable layer 34. This decoupling allows the structural design and materials used for the reflective layer 14 and those used for the deformable layer 34 to be optimized independently of one another.

FIG. 6D shows another example of an IMOD, where the movable reflective layer 14 includes a reflective sub-layer 14a. The movable reflective layer 14 rests on a support structure, such as support posts 18. The support posts 18 provide separation of the movable reflective layer 14 from the lower stationary electrode (i.e., part of the optical stack 16 in the illustrated IMOD) so that a gap 19 is formed between the movable reflective layer 14 and the optical stack 16, for example when the movable reflective layer 14 is in a relaxed position. The movable reflective layer 14 also can include a conductive layer 14c, which may be configured to serve as an electrode, and a support layer 14b. In this example, the conductive layer 14c is disposed on one side of the support layer 14b, distal from the substrate 20, and the reflective sub-layer 14a is disposed on the other side of the support layer 14b, proximal to the substrate 20. In some implementations, the reflective sub-layer 14a can be conductive and can be disposed between the support layer 14b and the optical stack 16. The support layer 14b can include one or more layers of a dielectric material, for example, silicon oxynitride (SiON) or silicon dioxide (SiO₂). In some implementations, the support layer 14b can be a stack of layers, such as, for example, a SiO₂/SiON/SiO₂ tri-layer stack. Either or both of the reflective sub-layer 14a and the conductive layer 14c can include, e.g., an aluminum (Al) alloy with about 0.5% copper (Cu), or another reflective metallic material. Employing conductive layers 14a, 14c above and below the dielectric support layer 14b can balance stresses and provide enhanced conduction. In some implementations, the reflective sub-layer 14a and the conductive layer 14c can be formed of different materials for a variety of design purposes, such as achieving specific stress profiles within the movable reflective layer 14.

As illustrated in FIG. 6D, some implementations also can include a black mask structure 23. The black mask structure 23 can be formed in optically inactive regions (e.g., between pixels or under posts 18) to absorb ambient or stray light. The black mask structure 23 also can improve the optical properties of a display device by inhibiting light from being reflected from or transmitted through inactive portions of the display, thereby increasing the contrast ratio. Additionally, the black mask structure 23 can be conductive and be configured to function as an electrical bussing layer. In some implementations, the row electrodes can be connected to the black mask structure 23 to reduce the resistance of the connected row electrode. The black mask structure 23 can be formed using a variety of methods, including deposition and patterning techniques. The black mask structure 23 can include one or more layers. For example, in some implementations, the black mask structure 23 includes a molybdenum-chromium (MoCr) layer that serves as an optical absorber, a layer, and an aluminum alloy that serves as a reflector and a bussing layer, with a thickness in the range of about 30-80 Å, 500-1000 Å, and 500-6000 Å, respectively. The one or more layers can be patterned using a variety of techniques, including photolithography and dry etching, including, for example, carbon tetrafluoride (CF₄) and/or oxygen (O₂) for the MoCr and SiO₂ layers and chlorine (Cl₂) and/or boron trichloride (BCl₃) for the aluminum alloy layer. In some implementations, the black mask 23 can be an etalon or interferometric stack structure. In such interferometric stack black mask structures 23, the conductive absorbers can be used to transmit or bus signals between lower, stationary electrodes in the optical stack 16 of each row or column. In some implementations, a spacer layer 35 can serve to generally electrically isolate the absorber layer 16a from the conductive layers in the black mask 23.

FIG. 6E shows another example of an IMOD, where the movable reflective layer 14 is self supporting. In contrast with FIG. 6D, the implementation of FIG. 6E does not include support posts 18. Instead, the movable reflective layer 14 contacts the underlying optical stack 16 at multiple locations, and the curvature of the movable reflective layer 14 provides sufficient support that the movable reflective layer 14 returns to the unactuated position of FIG. 6E when the voltage across the interferometric modulator is insufficient to cause actuation. The optical stack 16, which may contain a plurality of several different layers, is shown here for clarity including an optical absorber 16a, and a dielectric 16b. In some implementations, the optical absorber 16a may serve both as a fixed electrode and as a partially reflective layer.

In implementations such as those shown in FIGS. 6A-6E, the IMODs function as direct-view devices, in which images are viewed from the front side of the transparent substrate 20, i.e., the side opposite to that upon which the modulator is arranged. In these implementations, the back portions of the device (that is, any portion of the display device behind the movable reflective layer 14, including, for example, the deformable layer 34 illustrated in FIG. 6C) can be configured and operated upon without impacting or negatively affecting the image quality of the display device, because the reflective layer 14 optically shields those portions of the device. For example, in some implementations a bus structure (not illustrated) can be included behind the movable reflective layer 14 which provides the ability to separate the optical properties of the modulator from the electromechanical properties of the modulator, such as voltage addressing and the movements that result from such addressing. Additionally, the implementations of FIGS. 6A-6E can simplify processing, such as, e.g., patterning.

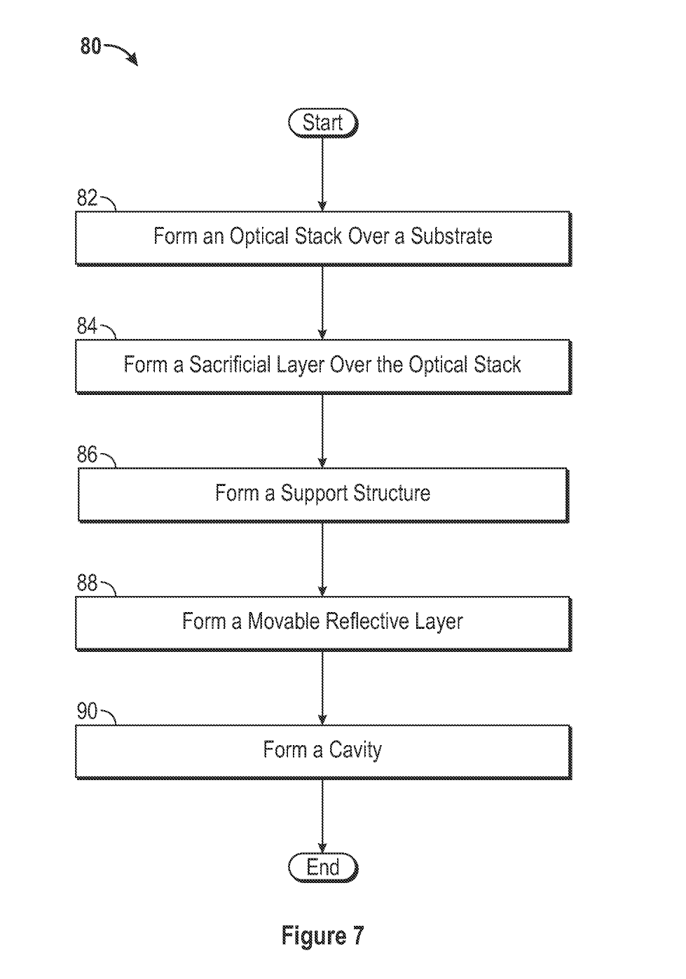

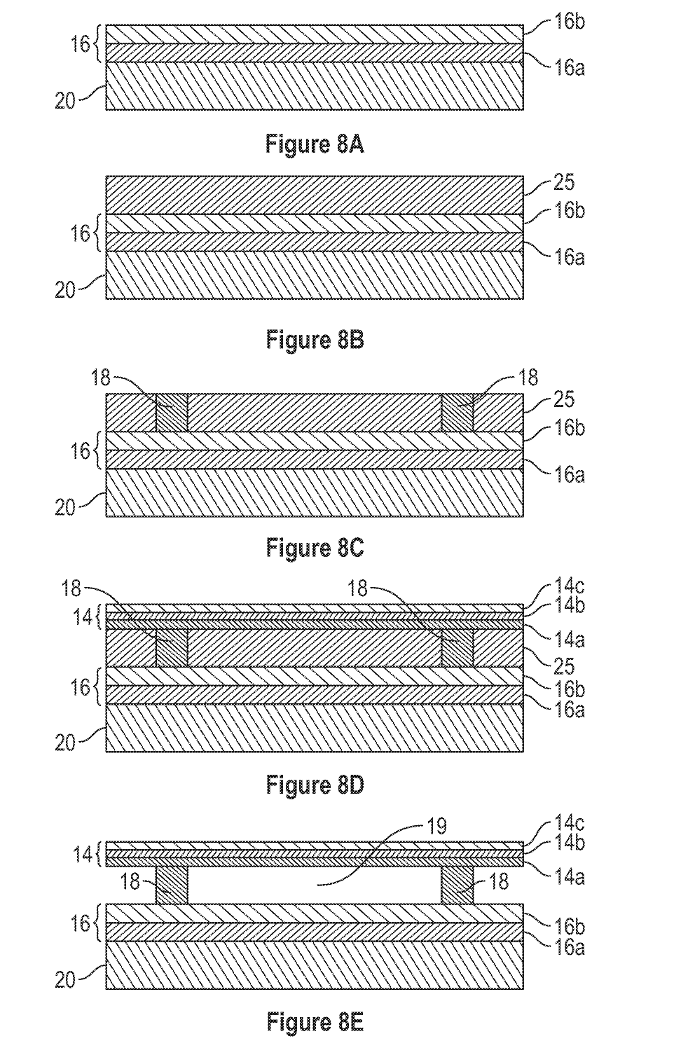

FIG. 7 shows an example of a flow diagram illustrating a manufacturing process 80 for an interferometric modulator, and FIGS. 8A-8E show examples of cross-sectional schematic illustrations of corresponding stages of such a manufacturing process 80. In some implementations, the manufacturing process 80 can be implemented to manufacture, e.g., interferometric modulators of the general type illustrated in FIGS. 1 and 6, in addition to other blocks not shown in FIG. 7. With reference to FIGS. 1, 6 and 7, the process 80 begins at block 82 with the formation of the optical stack 16 over the substrate 20. FIG. 8A illustrates such an optical stack 16 formed over the substrate 20. The substrate 20 may be a transparent substrate such as glass or plastic, it may be flexible or relatively stiff and unbending, and may have been subjected to prior preparation processes, e.g., cleaning, to facilitate efficient formation of the optical stack 16. As discussed above, the optical stack 16 can be electrically conductive, partially transparent and partially reflective and may be fabricated, for example, by depositing one or more layers having the desired properties onto the transparent substrate 20. In FIG. 8A, the optical stack 16 includes a multilayer structure having sub-layers 16a and 16b, although more or fewer sub-layers may be included in some other implementations. In some implementations, one of the sub-layers 16a, 16b can be configured with both optically absorptive and conductive properties, such as the combined conductor/absorber sub-layer 16a. Additionally, one or more of the sub-layers 16a, 16b can be patterned into parallel strips, and may form row electrodes in a display device. Such patterning can be performed by a masking and etching process or another suitable process known in the art. In some implementations, one of the sub-layers 16a, 16b can be an insulating or dielectric layer, such as sub-layer 16b that is deposited over one or more metal layers (e.g., one or more reflective and/or conductive layers). In addition, the optical stack 16 can be patterned into individual and parallel strips that form the rows of the display.

The process 80 continues at block 84 with the formation of a sacrificial layer 25 over the optical stack 16. The sacrificial layer 25 is later removed (e.g., at block 90) to form the cavity 19 and thus the sacrificial layer 25 is not shown in the resulting interferometric modulators 12 illustrated in FIG. 1. FIG. 8B illustrates a partially fabricated device including a sacrificial layer 25 formed over the optical stack 16. The formation of the sacrificial layer 25 over the optical stack 16 may include deposition of a xenon difluoride (XeF₂)-etchable material such as molybdenum (Mo) or amorphous silicon (a-Si), in a thickness selected to provide, after subsequent removal, a gap or cavity 19 (see also FIGS. 1 and 8E) having a desired design size. Deposition of the sacrificial material may be carried out using deposition techniques such as physical vapor deposition (PVD, e.g., sputtering), plasma-enhanced chemical vapor deposition (PECVD), thermal chemical vapor deposition (thermal CVD), or spin-coating.

The process 80 continues at block 86 with the formation of a support structure e.g., a post 18 as illustrated in FIGS. 1, 6 and 8C. The formation of the post 18 may include patterning the sacrificial layer 25 to form a support structure aperture, then depositing a material (e.g., a polymer or an inorganic material, e.g., silicon oxide) into the aperture to form the post 18, using a deposition method such as PVD, PECVD, thermal CVD, or spin-coating. In some implementations, the support structure aperture formed in the sacrificial layer can extend through both the sacrificial layer 25 and the optical stack 16 to the underlying substrate 20, so that the lower end of the post 18 contacts the substrate 20 as illustrated in FIG. 6A. Alternatively, as depicted in FIG. 8C, the aperture formed in the sacrificial layer 25 can extend through the sacrificial layer 25, but not through the optical stack 16. For example, FIG. 8E illustrates the lower ends of the support posts 18 in contact with an upper surface of the optical stack 16. The post 18, or other support structures, may be formed by depositing a layer of support structure material over the sacrificial layer 25 and patterning portions of the support structure material located away from apertures in the sacrificial layer 25. The support structures may be located within the apertures, as illustrated in FIG. 8C, but also can, at least partially, extend over a portion of the sacrificial layer 25. As noted above, the patterning of the sacrificial layer 25 and/or the support posts 18 can be performed by a patterning and etching process, but also may be performed by alternative etching methods.

The process 80 continues at block 88 with the formation of a movable reflective layer or membrane such as the movable reflective layer 14 illustrated in FIGS. 1, 6 and 8D. The movable reflective layer 14 may be formed by employing one or more deposition steps, e.g., reflective layer (e.g., aluminum, aluminum alloy) deposition, along with one or more patterning, masking, and/or etching steps. The movable reflective layer 14 can be electrically conductive, and referred to as an electrically conductive layer. In some implementations, the movable reflective layer 14 may include a plurality of sub-layers 14a, 14b, 14c as shown in FIG. 8D. In some implementations, one or more of the sub-layers, such as sub-layers 14a, 14c, may include highly reflective sub-layers selected for their optical properties, and another sub-layer 14b may include a mechanical sub-layer selected for its mechanical properties. Since the sacrificial layer 25 is still present in the partially fabricated interferometric modulator formed at block 88, the movable reflective layer 14 is typically not movable at this stage. A partially fabricated IMOD that contains a sacrificial layer 25 may also be referred to herein as an “unreleased” IMOD. As described above in connection with FIG. 1, the movable reflective layer 14 can be patterned into individual and parallel strips that form the columns of the display.

The process 80 continues at block 90 with the formation of a cavity, e.g., cavity 19 as illustrated in FIGS. 1, 6 and 8E. The cavity 19 may be formed by exposing the sacrificial material 25 (deposited at block 84) to an etchant. For example, an etchable sacrificial material such as Mo or amorphous Si may be removed by dry chemical etching, e.g., by exposing the sacrificial layer 25 to a gaseous or vaporous etchant, such as vapors derived from solid XeF₂ for a period of time that is effective to remove the desired amount of material, typically selectively removed relative to the structures surrounding the cavity 19. Other etching methods, e.g. wet etching and/or plasma etching, also may be used. Since the sacrificial layer 25 is removed during block 90, the movable reflective layer 14 is typically movable after this stage. After removal of the sacrificial material 25, the resulting fully or partially fabricated IMOD may be referred to herein as a “released” IMOD.

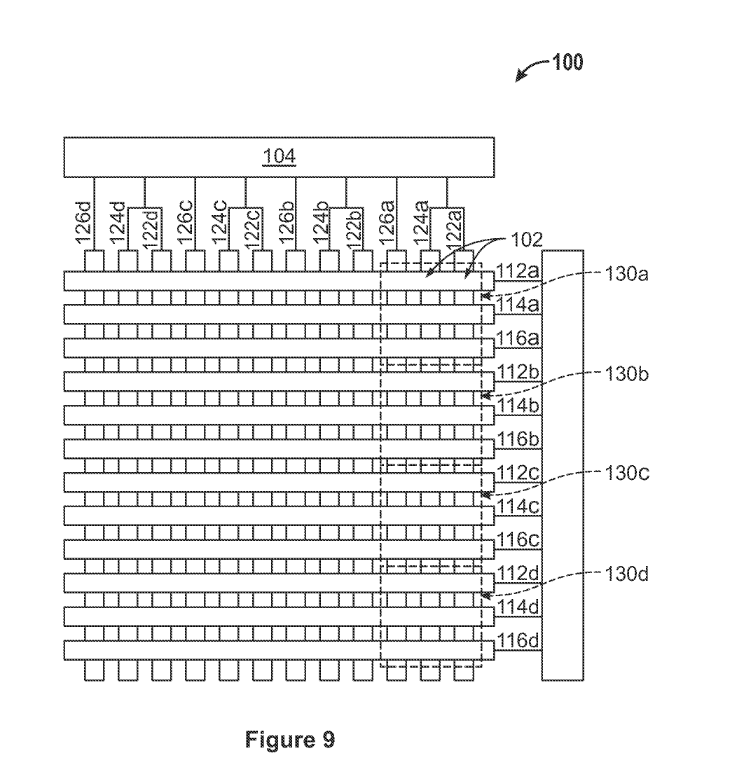

FIG. 9 schematically illustrates an example of an array 100 of display elements 102 including a plurality of common lines 112, 114, and 116 and a plurality of segment lines 122, 124, and 126. In some implementations, the display elements 102 may include interferometric modulators. A plurality of segment electrodes or segment lines 122, 124, and 126 and a plurality of common electrodes or common lines 112, 114, and 116 can be used to address the display elements 102, as each display element 102 will be in electrical communication with a segment electrode 122, 124, or 126 and a common electrode 112, 114, or 116. Segment driver circuitry 104 is configured to apply desired voltage waveforms across each of the segment electrodes 122, 124, and 126, and common driver circuitry 106 is configured to apply desired voltage waveforms across each of the column electrodes 112, 114, and 116. In some implementations, some of the electrodes may be in electrical communication with one another, such as segment electrodes 124a and 122a, such that the same voltage waveform can be simultaneously applied across each of the segment electrodes.

Still with reference to FIG. 9, in an implementation in which the display 100 comprises a color display or a monochrome grayscale display, the individual electromechanical elements 102 may comprise subpixels of larger pixels, wherein the pixels comprise some number of subpixels. In an embodiment in which the array comprises a color display including a plurality of interferometric modulators, the various colors may be aligned along common lines, such that a substantially all of the display elements along a give common line comprise display elements configured to display the same color. Certain implementations of color displays comprise alternating lines of red, green, and blue subpixels. For example, lines 112 may correspond to lines of red interferometric modulators, lines 114 may correspond to lines of green interferometric modulators, and lines 116 may correspond to lines of blue interferometric modulators. In one implementation, each 3×3 array of interferometric modulators 102 forms a pixel such as pixels 130a-130d. In the illustrated implementation in which two of the segment electrodes are shorted to one another, such a 3×3 pixel will be capable of rendering 64 different colors (a 6-bit color depth), because each set of three common color subpixels in each pixel can be placed in four different states. When using this arrangement in a monochrome grayscale mode, the state of the three pixel sets for each color are made to be identical, in which case each pixel can take on four different gray level intensities. It will be appreciated that this is just one example, and that larger groups of interferometric modulators may be used to form pixels having a greater color range at the cost of overall pixel count or resolution.

### Multi-Line Addressing Mode

In certain displays, the time required to write data to the display elements will place constraints on the overall rate at which the display can be written to. If each common line is separately addressed, the write time necessary for each line will determine the overall frame write time. In certain implementations, an increased refresh rate or frame rate of the display may be desired, and may be more important than the resolution or color range of the display for a good visual appearance to a user. In particular implementations, driver circuitry and display arrays which are capable of presenting high resolution images with a wide color range may be utilized in a variety of different “modes” of strobing the common lines of the array. These modes may be designed to reduce one or both of the resolution and the color range and in turn increase the potential refresh rate of the display and/or reduce power consumption by strobing multiple lines of the array at the same time. These modes are explained further below, and are referred to herein as “multi-line addressing modes” of display controller operation. First, the operation of these modes will be explained, followed by novel methods of mode control.

In particular implementations, the resolution can be effectively reduced by simultaneously applying the same waveforms across common lines corresponding to display elements of the same color. For example, if a write waveform is simultaneously applied across red common lines 112a and 112b to address those common lines, the data pattern written to the interferometric modulators along common line 112a will be identical to the data pattern written to the interferometric modulators along common line 112b. If write waveforms are simultaneously applied across green common lines 114a and 114b, and then across blue common lines 116a and 116b, the data pattern written to pixel 130a will be identical to the data pattern written to pixel 130b, causing pixel 130a to display the same color as pixel 130b. Although the term “simultaneously” is used throughout this discussion for the purposes of conciseness, the voltage waveforms need not be perfectly synchronized. As discussed above with respect to FIG. 5B, the write waveform may include an overdrive or address voltage during which the potential difference across a display element is sufficient to result in data being written to that display element given an appropriate segment voltage. So long as there is sufficient overlap between the overdrive or address voltages of the write waveforms applied across the common lines and the data signals applied across the segment lines that actuation of the display elements on all of the addressed common lines will occur, the write waveforms and data signals are considered to be applied simultaneously.

In comparison to a write process in which each common line is individually addressed, data has been written to pixels 130a and 130b in as little as half the time it would have taken to write separate data to pixels 130a and 130b, at the cost of decreased resolution. If this line multiplying process is applied to the remainder of the common lines in the display, the frame write time is considerably reduced.

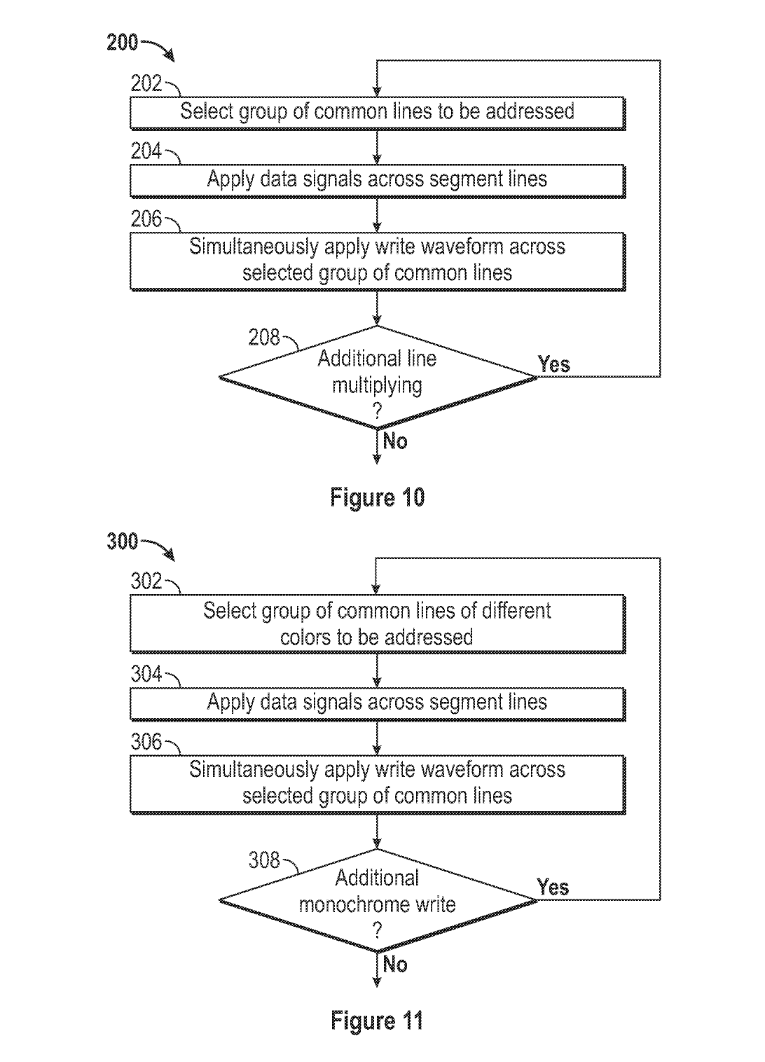

FIG. 10 is a flowchart illustrating a frame write process 200 which reduces the overall frame write time through the use of line multiplication. This particular frame write process may represent only a portion of the complete frame write, and may occur at any time during a complete frame write, including the beginning, middle, or end of the complete frame write. Thus, image data may already have been written to one or more common lines within the frame. In block 202, a pair or group of common lines to be simultaneously addressed is identified.

In block 204, a plurality of data signals are applied along segment lines. Simultaneously, in block 206 a first write waveform is simultaneously applied to at least two common lines in the array to address the waveforms. Such a write waveform may include, for example, a positive or negative overdrive or address voltage appropriate for the common lines being addressed, as described with respect to FIG. 5B above. Hold voltages may be simultaneously applied to multiple common lines not being addressed, and reset voltages may be applied to common lines prior to addressing the common lines. When the write waveform is applied along a pair or group of common lines to be addressed, the application of properly selected data signals along the segment lines will not result in an accidental actuation or accidental release of display elements along common lines not being addressed.

Although the flowchart of FIG. 10 illustrates block 204 as taking place before block 206, the desired actuation will occur so long as there is sufficient overlap between the write waveform and the plurality of data signals to allow all the electromechanical devices sufficient time to actuate or release in accordance with the applied data signals. The frame write time can thus be reduced by maximizing the overlap between the write waveform of block 206 and the data signals of block 204, and blocks 204 and 206 can occur in either order so long as there is overlap between the application of the signals.

In block 208, a determination is made as to whether any additional pairs or groups of common lines are to be simultaneously addressed. If so, the process returns to block 202 to select an appropriate pair or group of common lines to simultaneously address. If not, the process moves to further blocks which could include a termination of the frame write process if all necessary common lines have been addressed, or could include individual addressing of certain common lines. In addition, simultaneous addressing of pairs or groups of common lines may be interspersed with individual addressing of common lines, depending on the nature of the data to be written. For example, if a portion of the image data written to a display includes text or another still image, and another portion of the data includes a video which can be displayed at a lower resolution and which is located vertically between sections of text or still image, the portions of the display located above the video can be written by individually addressing those common lines, the portions of the display including the video can be written at a lower resolution by utilizing a line multiplying write process, and the write process may return to individual addressing of the common lines of the display for the portion of the display located below the video.

The particular method of line multiplication discussed above advantageously applies identical write waveforms to common lines in adjacent pixels, although other pairs of common lines may be simultaneously addressed in other implementations. Furthermore, even if the line multiplying method is used to simultaneously apply write waveforms to common lines in adjacent pixels, all of the lines in a given pair or group of pixels need not be written before writing lines in other groups of pixels. In particular, in certain implementations it may be advantageous to address multiple pairs or groups of common lines of the same color before addressing common lines of another color. For example, red common lines 112a and 112b may be simultaneously addressed, followed by a subsequent write process which simultaneously addresses red common lines 112c and 112d. Because different voltage waveforms may be used to address common lines of different color display elements, it may be advantageous to utilize the write waveform appropriate for a particular color for multiple pairs or groups of common lines before addressing common lines of another color. In particular implementations, any number of pairs or groups of common lines of a given color may be sequentially addressed before addressing common lines of another color. For example, in certain implementations, five pairs or groups of common lines of a given color may be addressed before common lines of another color are addressed, although larger or smaller numbers of pairs or groups may be used, as well.

In addition, although the simultaneous application of substantially identical waveforms to two common lines is discussed herein, further increases in refresh rate or frame write or reductions in power usage may be achieved by simultaneously applying substantially identical waveforms to more than two common lines.

In some methods of updating data on a display, charge buildup on particular display elements may be reduced by altering the polarity of the write waveforms applied to the common line. In one implementation, which may be referred to as frame inversion, a given frame is fully addressed using write waveforms of a particular polarity, and a subsequent frame is fully addressed using write waveforms of the opposite polarity. In further implementations, however, the polarity of write waveforms may be altered during a single frame write. In a particular implementation, which may be referred to as line inversion, the polarity of the write may be altered after addressing each line, and the polarity used to address a particular line will be changed in subsequent frames. If the display is being updated in a substantially linear fashion, this may result in adjacent lines being addressed by write voltages having opposite polarities. Thus, in certain implementations, it may be advantageous to utilize a given write waveform having a given polarity to write to, for example, every other red common line with a positive polarity for some number of common lines, before writing to the skipped red common lines with a negative polarity.

Polarity inversion within a frame can be applied to a write process in which line multiplying is used as well. In one implementation, red lines 112c and 112d may be addressed using the opposite polarity of that used to address red lines 112a and 112b within a given frame write. In an implementation such as the one described above where a write waveform with a given polarity is used for multiple sequential addressing operations, red lines 112a and 112b may be addressed using a first polarity, and red lines 112c and 112d may be skipped while some number of additional pairs or groups of red lines are written using the first polarity. After some number of pairs or groups have been addressed using the first polarity, red lines 112c and 112d may be addressed using the opposite polarity.

If polarity inversion is utilized, addressing a certain number of lines of one color using a first polarity need not be followed by addressing a certain number of lines in the same color using the opposite polarity. In other implementations, positive red write processes may be followed by, for example, negative blue write processes, or positive green write processes.

In another implementation, a color display may be driven in a monochrome mode or other mode which reduces the available color range. The process of updating a display in this manner can reduce the necessary time to refresh the display without decreasing the resolution of the display. In one implementation, the display can be driven in a monochrome manner by simultaneously applying write waveforms to adjacent common lines. For example, in an RGB display such as the one depicted in FIG. 9, the three adjacent common lines 112a, 114a, and 116a which extend through pixel 130a will be simultaneously addressed by applying a write waveform across each of these three common lines. In certain implementations, a write voltage specific to the color of the common line being addressed may be used on each of these three common lines, and in other implementations, a single write waveform selected to be suitable to address each of the various colors of display elements within the common lines may be used. If appropriate write waveforms are chosen, identical subpixels will be actuated on each of the common lines, and the pixel 130a can be driven as a grayscale pixel having four potential shades.

In other implementations, the range of possible colors can be reduced to increase the potential refresh rate without reducing the display to a monochrome display. For example, in a display having display elements of three distinct colors, two of the colors in a given pixel may be simultaneously addressed while the other color is independently addressed, yielding a color range which is more robust than monochrome but less robust than that possible if all three colors were independently addressed. In alternate implementations, one or more color could be left unaddressed.

FIG. 11 is a flowchart illustrating a frame write process 300 for reducing the overall frame write time of a display through the use of a monochrome mode for at least a portion of the display. As discussed above with respect to the frame write process 200, this process may be used for the entire frame write, or only during portions of the frame write, for example, only at the beginning, middle, or end of the frame write. Thus, image data may be written to lines before and/or after process 300.

At block 302, a group of common lines to be addressed is selected. In a display having three different colors of display elements, such as an RGB display, the group of selected colors may include the adjacent common lines of each color extending through a given pixel. At block 304, data signals are simultaneously applied across a plurality of segment lines. At block 306, write waveforms are simultaneously applied across each of the selected common lines. As discussed above, because this process includes simultaneous addressing of display elements of different colors, different write waveforms specific to the color of the common lines may be used for each of the colors being addressed, although a single write waveform appropriate for all colors being addressed may also be used in alternate implementations. Given sufficient overlap between blocks 304 and 306, the data signals result in the writing of image data to the addressed common lines.

At block 308, a determination is made as to whether or not the next line write will be a monochrome line write which will simultaneously address multiple common lines. If yes, the process returns to block 302 to select the common lines to be simultaneously addressed. If not, the process may move on to other steps, including color line writes which address only a single common line, or the frame write may be complete.

In further implementations, line multiplying of the type discussed above may be used in only certain sections of a display, depending on the particular information to be displayed. Many implementations of display devices frequently display information such that large portions of the data is identical (or nearly identical) on different common lines. For example, space between lines of text on an eBook or other text display device may be solid white, or another color. In such an implementation, where the data to be written to pixels along multiple common lines remains constant for multiple common lines, the column lines sharing identical segment data may be written to or addressed simultaneously. When a write waveform is simultaneously applied to each of these common lines, the data on the segment lines will be written to each of the common lines being addressed. In addition to reducing the overall time required to complete a frame write, additional power can be saved by minimizing segment voltage switches.

Although the above implementations have described the use of 3×3 pixels, it will be understood that pixels and display elements of any desired size and shape may be used in conjunction with the methods and devices discussed herein. For example, if a pixel covers more than three segment lines, or if each of the segment lines are independent of one another, an increased color or grayscale range can be provided.

The above drive schemes and other techniques need not be used in conjunction with an increase in the refresh rate of a display. For example, many of the above methods can result in significant reductions in power consumption, and may be applied in order to reduce the power utilized by a display. A reduction in power usage may be of particular interest in battery-powered or other mobile devices where a reduction in power usage can result in longer battery life.

Sometimes, such as in the display of video or other animation, high refresh rate or frame rate may be more important to good visual appearance than the resolution of the display. For example, a low-resolution preview image may be shown and then replaced with a full-resolution image, or a GUI including a zooming animation may display the zooming animation at a lower resolution and then return to a higher resolution when the zooming animation is complete. In some implementations, resolution is sacrificed for higher frame rate by simultaneously applying identical voltage waveforms across multiple common lines.

In further implementations, when the resolution of the display is greater than the resolution of the source data, simultaneously writing identical data to multiple display elements can reduce the frame write time without having any negative visual effect on the resulting image, as identical data would already have been written to certain adjacent display elements. Video data, for example, is frequently viewed on displays which have a higher resolution than the video data itself, although many other types of image source data may be lower resolution than the display to which the image data will be written. The use of line multiplication to write the same data to multiple lines advantageously decreases the frame write time, increasing the possible refresh rate without a detrimental impact on the final display image.

It is one aspect of some implementations that these “multi-line addressing” modes can be entered and exited by the display controller under the control of a host executing host software. In some implementations, a host can be a device or computer program that provides services to an end user, which can include generating, forwarding, or otherwise providing images for a display to enable the user to view content. A host may be or include a general purpose processor circuit configured to run application programs such as web browsers, word processing programs, games, and the like. For example, a mobile device (e.g., a mobile phone or computing device) can be a host that includes a display either integrated with or separate from the host. The host software has a large amount of information concerning the nature of the data that the host software wants to be displayed. Based on this information, the host can put the display controller into a mode that is optimal for the nature of the display data. For example, the host software may know that it is decoding a H.264 video stream that has a frame rate faster than the update rate for the display if the display had to update each line separately. In this case, the host may put the display controller into a multi-line addressing mode (with, for example, half the maximum display resolution) so that the display can keep up with the frame rate. This mode control could be provided, for example, by a register in the display controller that can be written to by the host, where the stored register value is read by the controller to determine its operational mode.

As another example, the host may be sending QVGA data (320×240) to the display. As this is very low resolution image data compared with a typical pixel resolution of the display, the host could put the display controller in a 320×240 resolution multi-line addressing mode (for example, one quarter native resolution) to increase refresh rates and/or conserve power.

Another example is a host program receiving touch screen inputs such as a pinch for zooming that cause rapid display changes. The host could sense these inputs, and put the display into a low resolution, fast update mode during these updates, and then switch the display controller back to full resolution mode when the display data is no longer changing quickly. As one example of this, a swipe motion may begin a scrolling action on the display that starts at a fast scrolling speed that progressively slows to a stop. The low resolution fast update mode could be used from immediately following the swipe until the scroll speed drops below a threshold, and then the display could be put into a high resolution slower update mode. In some implementations, the host may automatically select a multi-line addressing mode in response to other user inputs, including but not limited to, input from a pointing device (e.g., mouse, touchpad, pointing stick, trackball, or stylus), an accelerometer, a keyboard, a gyroscope, a voice command, a camera, or any other tactile or non-tactile user input device.

In some cases, these modes could be entered and exited during writes of a single frame. If there is a mode register in the display controller, this could be checked between each line strobe (or between completion of each line of pixels) so that a multi-line addressing mode could be implemented for portions of a frame. This would be useful if the image data had significant regions of identical lines, where these regions could be addressed in a multi-line addressing mode as described above, but the rest of the frame is strobed a line at a time. In other cases, the controller can be configured to prevent mode changes from occurring too quickly when such changes detrimentally affect visual appearance of the display. If, for example, the controller is instructed to change modes, it could ensure that a certain number of lines or frames have been written using the current mode before making the switch.

If the host is running a web browser, for example, and a user is accessing web pages, the host may set the display controller to full resolution mode since frame updates with new images will occur infrequently. If a Flash° window with video is opened, a multi-line addressing mode can be set for those lines of the display that contain the window. These modes can also be selected by the host based on the status of a video window. Full resolution mode can be used if the video is paused or stopped, for example. In one implementation, where the mode selection is made by the host, the host may refrain from writing display data to the frame buffer that would be ignored in the line doubling mode. In this manner, the energy expended in writing data to the frame buffer could be saved.

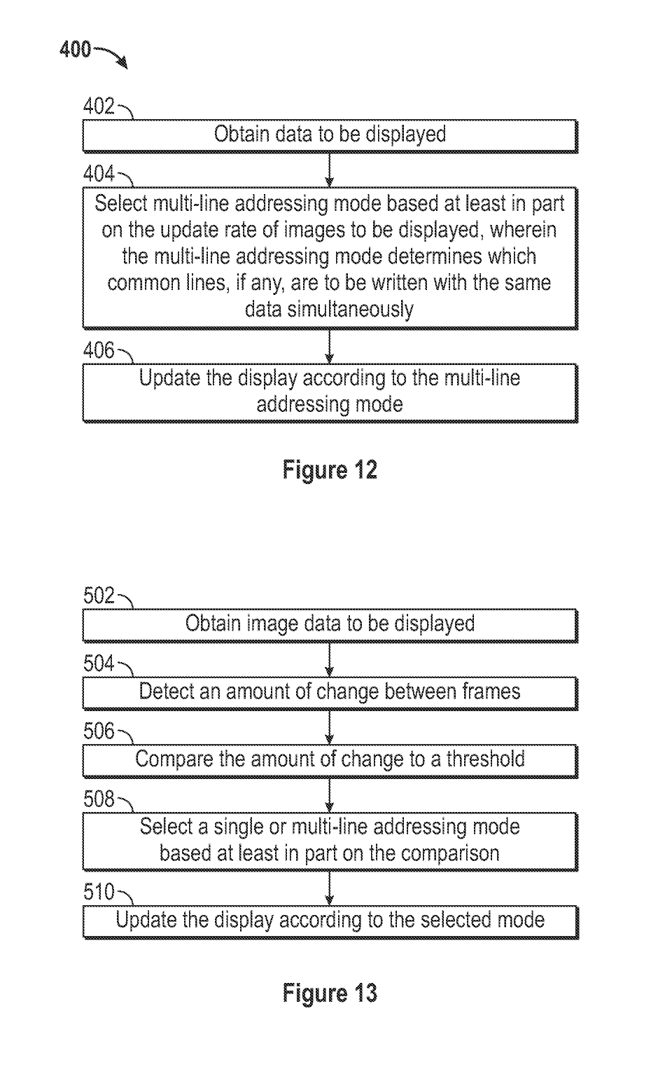

FIG. 12 is a flowchart illustrating an example process 400 for updating a display according to a multi-line addressing mode, where the selection of the multi-line addressing mode is based, at least in part on the data to be displayed. In block 402, the data to be displayed is obtained. In block 404, a multi-line addressing mode is selected, the selection based at least in part on the data to be displayed. The multi-line addressing mode determines which common lines, if any, are to be written with the same data simultaneously. For example, as described above, if the data to be displayed is video, a multi-line addressing mode which increased the display refresh rate may be selected. For example, in some implementations, a multi-line addressing mode may be selected that writes common lines of adjacent pixels with the same data, resulting in reduced resolution. In other implementations, a multi-line addressing mode may be selected that writes common lines corresponding to different color subpixels in the same line of pixels with the same data, resulting in a monochrome color depth. In block 406, the display is updated according to the selected multi-line addressing mode.

With further reference to the example shown in FIG. 12, the selection of the multi-line addressing mode is based, at least in part, on the data to be displayed. For example, in some implementations, the selection of the multi-line addressing mode may be based on the format of the data itself (e.g., image, video, text). The selection of the multi-line addressing mode may also be based on something other than the data to be displayed. For example, the selection of a multi-line addressing mode may also be based in part on power efficiency considerations, which may be raised by, for example, remaining battery charge or user input.

In some implementations, the host and/or controller can use information about which lines of an image have changed in order to selectively update only lines that have changed more than some threshold amount. Using the video window display as an example, if the window is in one portion of the image, and the remainder of the image is not changing, then only the lines containing the window are updated. This can be combined with the multi-line addressing described above such that only the lines with the window are updated, and those lines are updated in a multi-line addressing mode.

As another example, the host may determine whether the images to be displayed are changing. If the images are changing (e.g., video is being displayed), then the host may select a multi-line addressing mode corresponding to a higher frame rate. To determine whether an image or a portion of an image has changed, the host may compare one image to a subsequent image. The determination of whether an image has changed may include comparing an entire first image (or a portion thereof) to an entire second image (or a portion thereof). In some implementations, the host may instead compare the outputs of an algorithm that has been run on the image data. For example, the host may compare a cyclic redundancy check (CRC) value for the first image (or a portion thereof) to a CRC value of the second image (or a portion thereof).

When the addressing mode is based on changes in the image data between frames, it can be useful to consider the amount of the change between frames when deciding what addressing mode to use. Some images, like desktop wallpaper with a clock icon that changes every second, or a page of text with a blinking cursor, have only small portions that change between images. For these kinds of changing images, it is not necessary, and visually undesirable, to use a multi-line addressing mode on the entire display when a CRC check of the entire image determines that a change has occurred. When a display is being updated with these kinds of images, it may be useful to use a single line addressing mode even for the changed frames.

FIG. 13 is a flowchart illustrating a method of selecting a single or multi-line addressing mode based at least in part on an amount of change in image data to be displayed. At block 502, image data to be displayed is obtained. This may be two or more successive image frames, a first one of which is currently being displayed. At block 504, an amount of change between image frames is detected. In one implementation, this may be done by computing a difference between the image data values for each pixel of two successive incoming frames of image data. At block 506, the amount of change is compared to a threshold. This comparison could take many forms. For example, from the locations of the determined changed pixels, the number of rows containing a changed pixel can be determined. This number can be compared to a threshold set to 5%, 10%, or any suitable value of the total number of rows. At block 508, a single or multi-line addressing mode can be selected based on the comparison. If the number of changed rows is above the threshold, a multi-line addressing mode with a fast update rate may be selected for writing the next frame. If the number of changed rows is less than or equal to the threshold, a single line addressing mode with a slower update rate but higher resolution may be selected. At block 510, the display is updated according to the selected mode. This will prevent low resolution multi-line addressing from being performed on a whole frame when only a small portion of the image is different. In some implementations, if a series of rows is different, but the remainder of the frame is the same, only the changed rows may be written with a multi-line addressing mode, and the remainder of the frame may be written in a single line addressing mode.

In some implementations, the number of changed columns can be determined based on the changed pixel positions. This can be used to adjust a segment transition stagger that extends the line time used to write each common line. In many implementations, the segment transitions can be staggered in time from the start of the line time. This can be useful for some images where there are many segment transitions from one line to the next, which causes some cross talk between the segment electrodes and the common electrode being written. The stagger reduces the cross talk and reduces the effect the segment transitions have on the common line waveform. If the number of changed columns exceeds a threshold, the stagger can be reduced or eliminated. This results in a reduction in line time, allowing a faster frame update. Although reducing or eliminating the stagger may result in more errors when the data is written, visual appearance may still be improved with the faster update when a large change between successive images is detected.

The determination of an amount of change between successive image changes can be used in other ways as well. For example, if image frames are being received from an image source at a rate faster than the display can be written, even in a multi-line addressing mode, some of the frames are discarded and not written at all. If a series of frames is received for display, and the differences between successive frames is determined prior to display, then selective discarding can be performed where images that are less different than neighboring images are preferentially discarded, allowing a smoother visual appearance for those portions of the image stream where more significant changes between images are occurring.

### Mode Selection and Spatial Distribution of Changed Image Regions

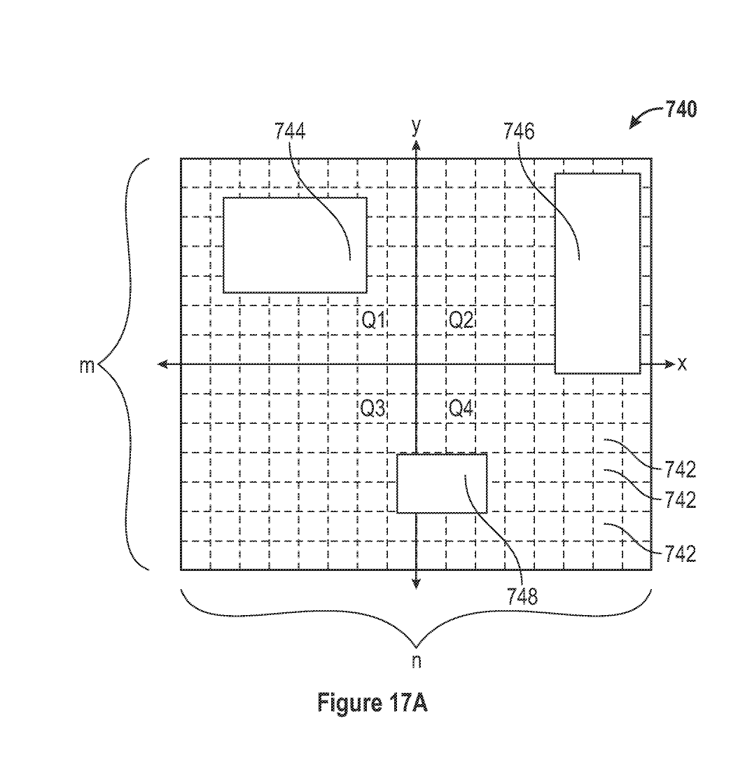

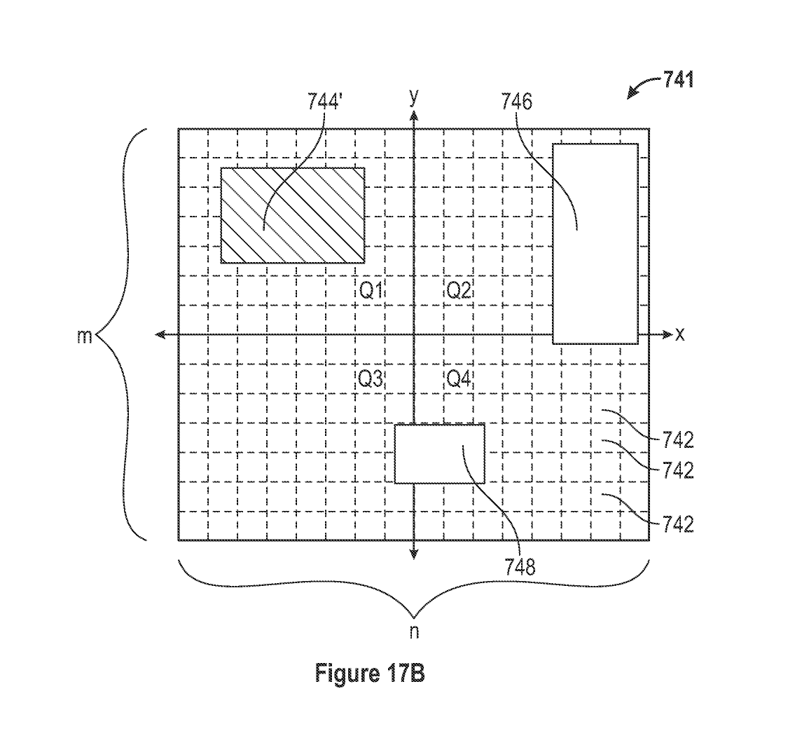

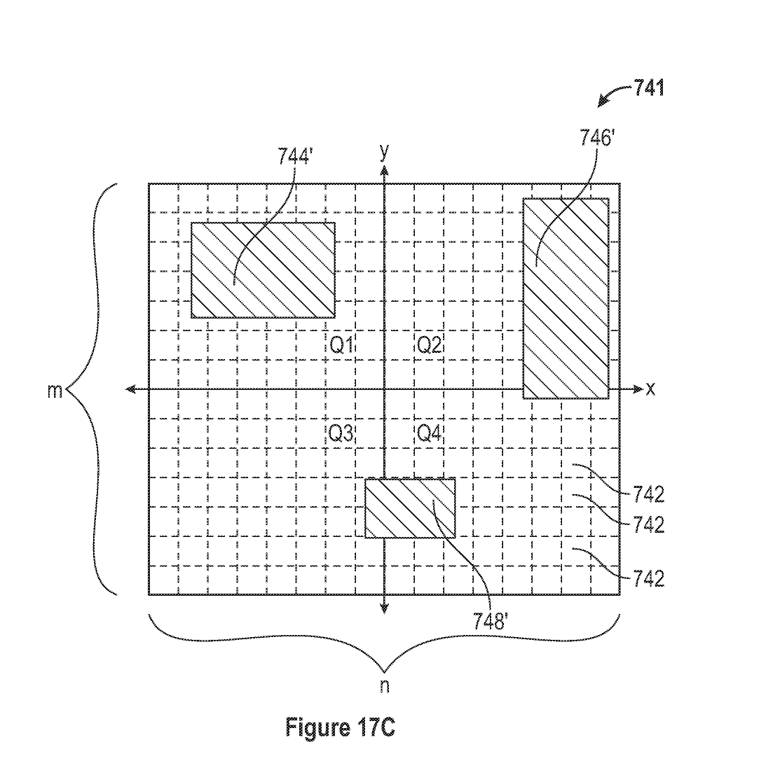

In some implementations, it can be desirable to select (or switch between) different display modes, such as, for example, a high resolution mode (one example being a single common line addressing mode) or a low resolution mode (one example being a multi-line addressing mode), in a manner that reduces abrupt transitions between frames while ensuring that the selected mode is appropriate for the nature of data to be displayed and the preferences of the user. In some instances, image data may only change in a localized region between frames, while in other instances, image data may change throughout many different regions scattered throughout each frame. Thus, in some implementations, it can be advantageous to select high or low resolution modes based at least in part on a spatial distribution of changed image regions over a series of frames, as discussed in more detail below. In some implementations discussed below, for example, each image can be divided into a plurality of discrete image regions that include one or more pixels. Each image region can be substantially the same size and shape, or each image region can be a different size or shape. In some implementations, such as in FIGS. 17A-C and 18A-C, each image can be divided into a “checkerboard” arrangement of separate image regions each having a particular location in each image frame.

As an example, a user may view text on a display in the high resolution mode, then open a video window in only one portion of the display. In this case, the user is using much of the display space to view the text, while simultaneously viewing the video in a smaller portion of the display. In many cases, as described above, it can be desirable to view video data at a higher refresh rate at the expense of resolution in order to give the user a better visual experience of the changing image data over time. However, in this case, the user may obtain a better visual display appearance by continuing to view the text at high resolution on most of the display while viewing the smaller video window at the same high resolution and lower refresh rate. Even though the video is playing at a lower refresh rate and higher resolution than might be normally desirable for video, in this case, the high resolution mode may be preferable since the video is concentrated or localized in only a relatively small portion of the display.

If, on the other hand, the user switches from reading text to playing a video game or viewing a movie on the entire display or on a large portion of the display, it can be desirable to switch to the low resolution mode to refresh the display at a higher rate. Similarly, if a user is playing a video game on a large portion of the display in the low resolution mode and switches to reading text, it can be desirable to switch to the high resolution mode to refresh the display at a lower rate.

As mentioned above, the host software has a large amount of information concerning the nature of the data that the host software wants to be displayed. In addition to having information about image formatting and user inputs (e.g., touch screen inputs), the host software also has information about how different regions of an image can change from frame to frame. It can therefore be advantageous to utilize the host's knowledge of the spatial distribution of changed image regions to determine whether to select the high or low resolution modes.

For example, when the addressing or resolution mode is based on changes to regions of an image over a series of frames, it can be useful to consider the amount of the change to each image region between frames when deciding what addressing or resolution mode to use. As above, to determine whether a region of an image has changed, the host may compare one image to a subsequent image. The determination of whether an image region has changed may include comparing an image region in a first frame to a corresponding image region in a second frame, or pixels in the first frame to corresponding pixels in the second frame. In some implementations, the host may instead compare the outputs of an algorithm that has been run on the image data, such as a CRC check. In still other implementations, the host can identify how many display elements (e.g., interferometric MEMS display elements) within the image region change from frame to frame to determine whether the image region encompassing those display elements changes from frame to frame.

The host can then compare the amount of change in each image region to a threshold to determine whether each image region is a changed image region, e.g., an image region that substantially changes from frame to frame. For instance, the host can compare the number of display elements within an image region that change from frame to frame to a threshold, such as 5%, 10%, 20%, 30%, 40%, 50%, 60% or any other suitable percentage of display elements within the image region.

Once the host identifies any changed image regions, the host can then analyze the spatial distribution of the changed image regions to determine whether to select the high resolution mode or the low resolution mode. If the spatial distribution of changed image regions is substantially concentrated in a relatively small portion of the frame, then the host can select the high resolution mode. In that case, changed image regions are localized or concentrated in a particular portion of the frame, and there is no need to switch to the low resolution, high refresh rate mode. Indeed, switching to the low resolution mode in these instances can unnecessarily degrade the quality of the displayed image (e.g., text, still images, etc.) if the changing part of the image is small and localized. On the other hand, if the spatial distribution of changed image regions is substantially scattered across the frames, then the host can switch or select the low resolution mode. In that case, larger distributed portions of the image are changing from frame to frame, and the higher refresh rate (low resolution) mode may be desirable.

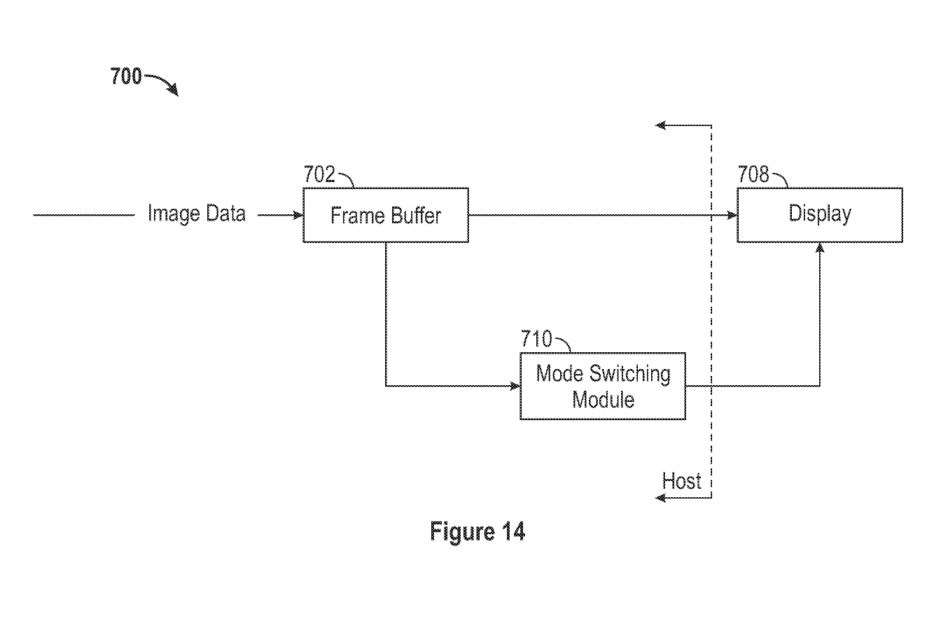

FIG. 14 shows an example block diagram illustrating one implementation of a system for selecting display modes in a display. In some implementations, as illustrated in FIG. 14, a system 700 for selecting display modes can include a frame buffer 702 that receives image data from an image source and stores image data for a series of frames to be displayed on a display 708.

The system 700 can also include a mode switching module 710 configured to select a high or low resolution mode based at least in part on the spatial distribution of changed image regions over a series of frames. As illustrated in FIG. 14, the mode switching module 710 can be located in the host in some implementations. In this manner, the mode switching module 710 can switch the display 708 between high and low resolution modes based on image data from the frame buffer 702. In addition, having the mode switching module 710 in the host can save power in some implementations. For example, the mode switching module 710 can coordinate with the frame buffer 702 to send images to the display 708 at the same refresh rate as the display 708, saving power at the host. In addition, the mode switching module 710 can further save power at the host by telling host processing circuitry when the display 708 goes into a hold mode. In that case, processing circuitry in the host can be temporarily turned off to match the hold modes in the display 708. In other implementations, the mode switching module 710 can be integrated with a display driver and/or a display processor. Also note that while the mode switching module 710 is shown as being part of the host in FIG. 14, in other implementations, the mode switching module 710 can also be integrated with or programmed into the display 708.

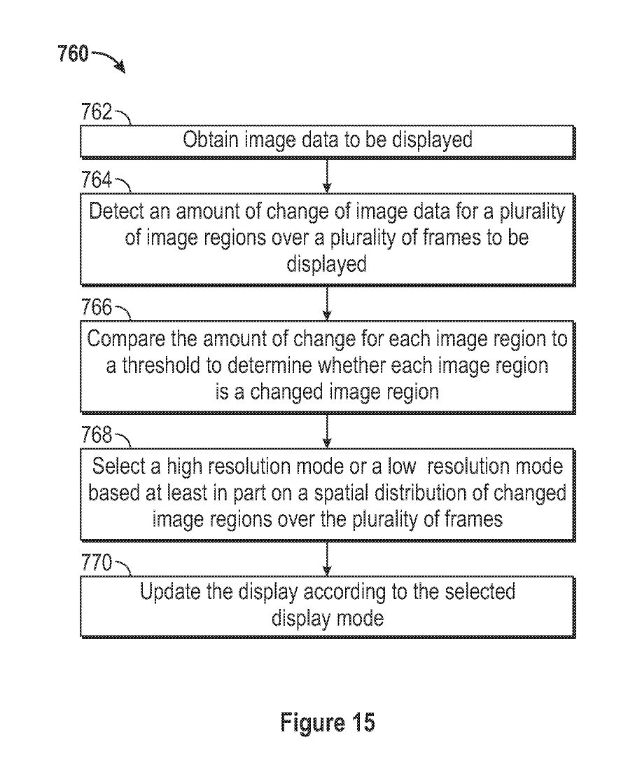

FIG. 15 is a flowchart illustrating a method of selecting a high or low resolution mode based at least in part on a spatial distribution of changed image regions. The method 760 begins at block 762, where image data to be displayed is obtained. This may be two or more successive image frames, a first one of which is currently being displayed. In some implementations, the image data can be obtained from the frame buffer 702, or from another image source.

The method 760 can proceed to block 764 to detect an amount of change of image data for a plurality of image regions over a plurality of frames to be displayed. As mentioned above, this can be accomplished by comparing an image region in a first frame to a corresponding image region in a second frame, or by comparing pixels in the first frame to corresponding pixels in the second frame. This may be done, e.g., by computing a difference between the image data values for each pixel of two or more successive incoming frames of image data. The host can also identify how many display elements (e.g., interferometric MEMS display elements) within the image region change from frame to frame to determine how much the image region encompassing those display elements changes from frame to frame.

Turning to block 766, the amount of change for each image region is compared to a threshold to determine whether each image region is a changed image region. As mentioned above, this can be done in a variety of ways. For instance, the number of display elements within an image region that change from frame to frame can be compared to a threshold. In some implementations, the threshold can be 5%, 10%, or any other suitable percentage of display elements within the image region. If the threshold is exceeded, then the image region is a changed image region. Alternatively, if some percentage of a contiguous area of a particular image region (which can contain numerous pixels and display elements) changes by a certain threshold (e.g., 5%, 10%, or any other suitable percentage), then the image region is a changed image region.

In block 768, a high resolution mode or a low resolution mode is selected based at least in part on a spatial distribution of changed image regions over the plurality of frames. As above, if the changed image regions are concentrated or localized within a portion of the image, then the high resolution mode may be selected. If the changed image regions are instead scattered or widely distributed across the frames, then the low resolution mode may be selected. In block 770, the display is updated according to the selected mode, e.g., the high or low resolution modes.

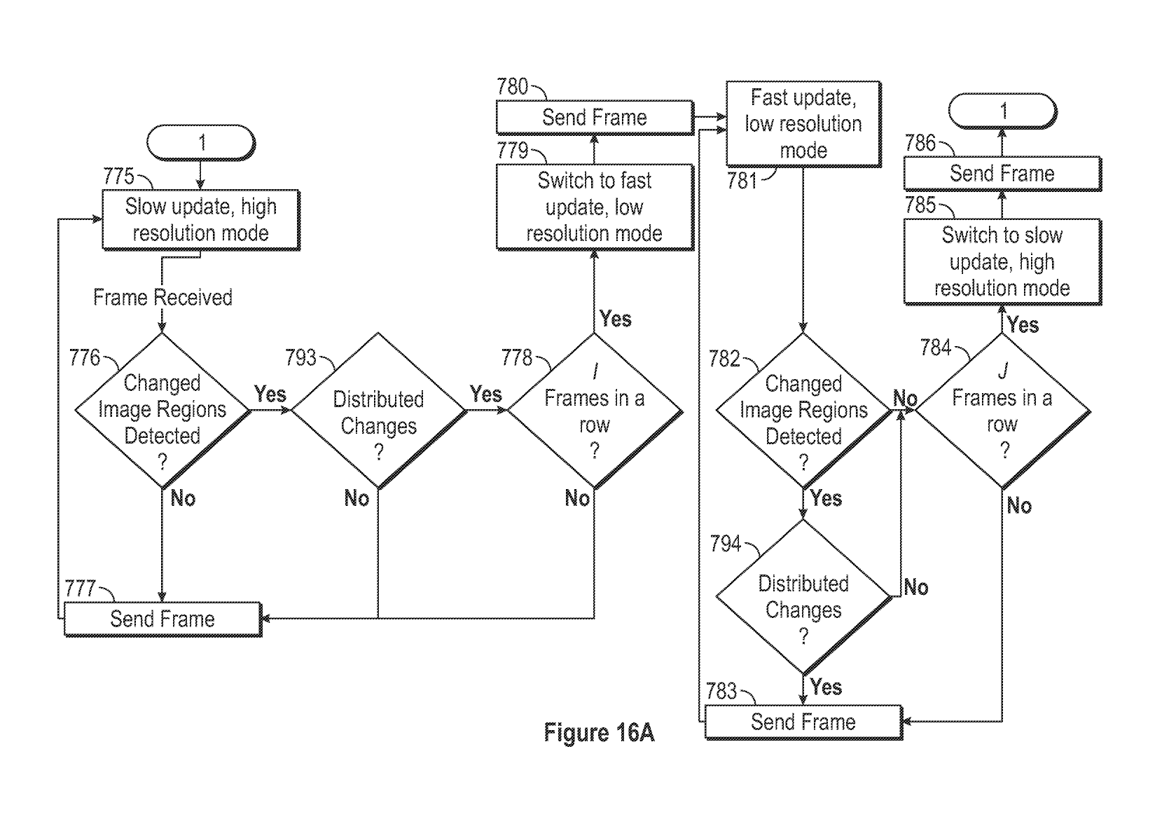

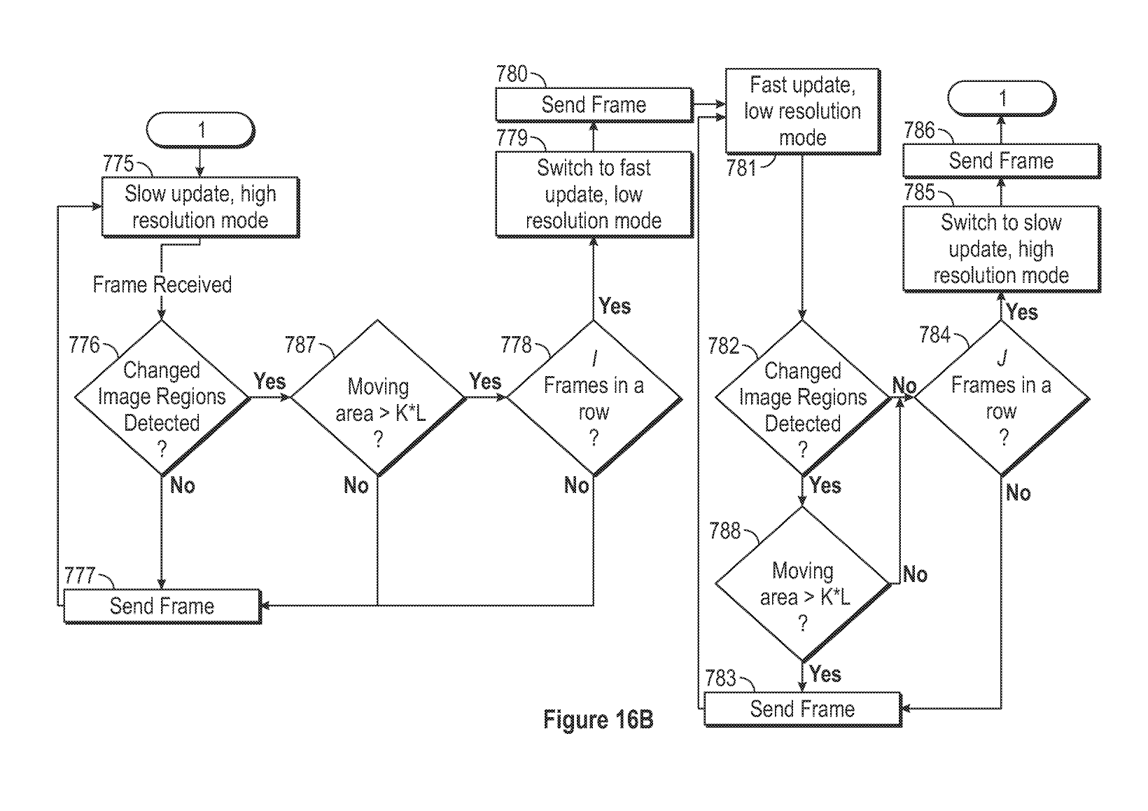

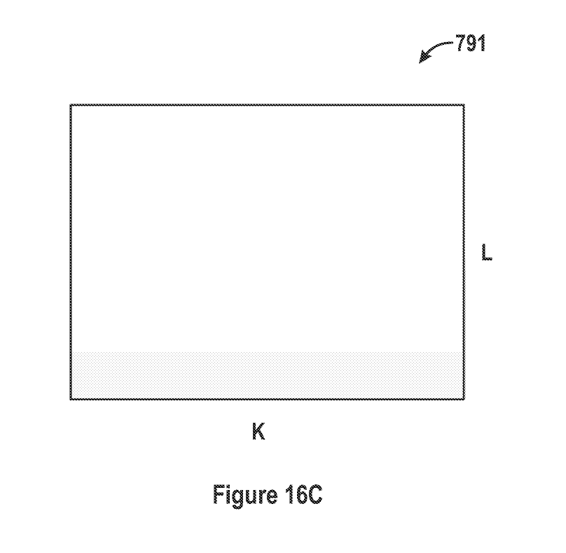

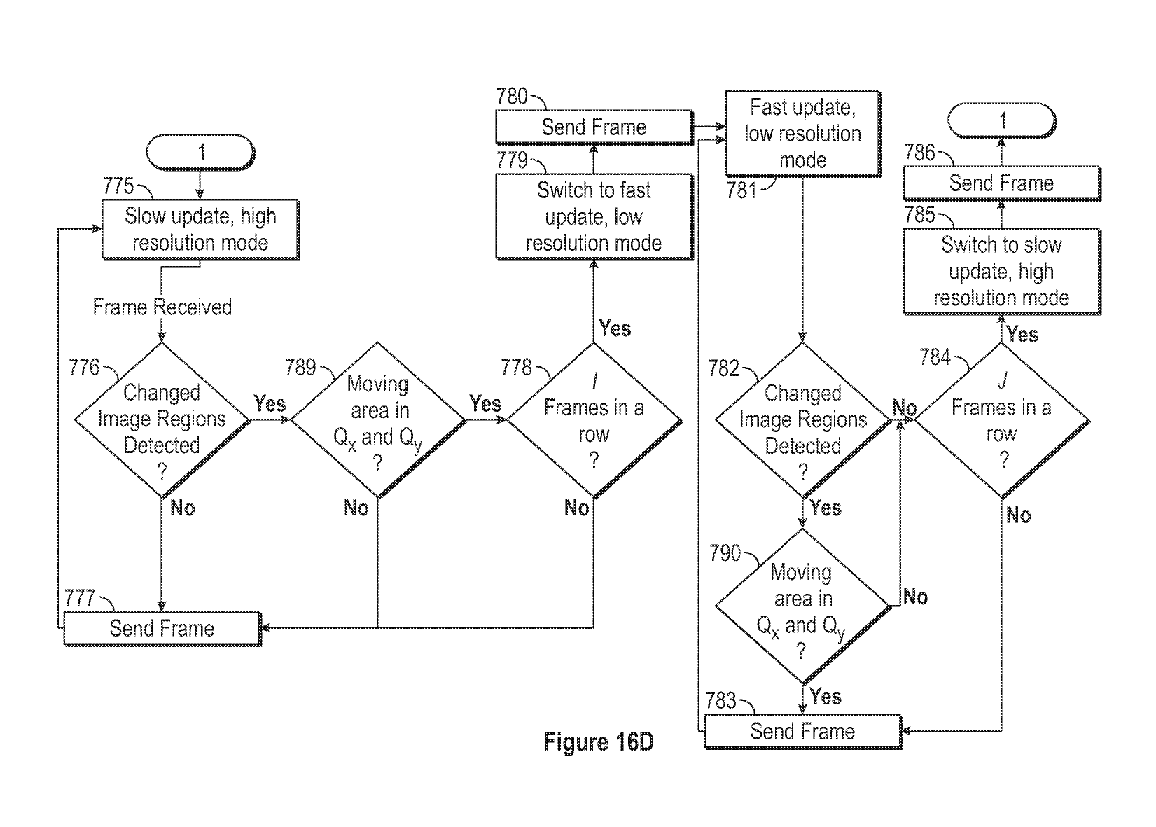

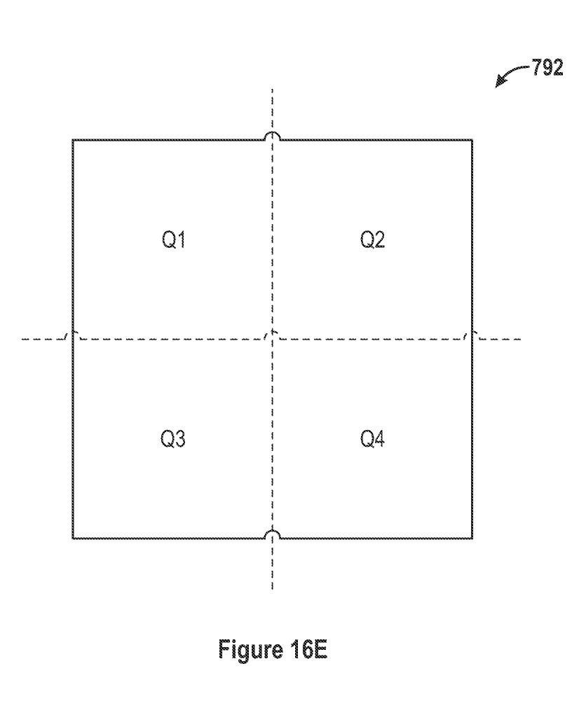

FIG. 16A is a flowchart illustrating a method of switching between high and low resolution modes in a display. For instance, the method can begin at block 775 in a slow update, high resolution mode (such as a single line addressing mode). After receiving image data from an incoming frame, mode switching module circuitry can determine whether any changed image regions are detected in block 776. If no changed image regions are detected, then circuitry can send the frame to the display in block 777 and can remain in the slow update mode by returning to block 775.

If changed image regions are detected in block 776, then the method can transition to block 793, in which processing circuitry can determine whether the changed image regions are distributed across the display or whether they are localized in a portion of the display. If the changed image regions are not distributed, then circuitry can send the frame to the display in block 777, and the display can remain in the slow update mode of block 775. In this instance, any changed image regions may not be spatially scattered across the frame, e.g., in situations where there may be only small changes or small areas of change to an image showing primarily text.

If, however, there are distributed changes, then the mode switching module circuitry can determine whether the changes occur over I frames in a row in block 778. If the changes occur over less than I number of frames, then switching to low resolution mode may cause a less desirable appearance than remaining in high resolution mode, even if the changes are scattered across the image. For example, the distributed changes may occur for only a few frames, in which case a viewer may not be able to resolve the motion or notice any substantial negative artifacts. Thus, if the changes occur in less than I frames, the frames are sent in block 777 to the display, and the display can remain in slow update, high resolution mode in block 775. If, however, the changes do occur in more than I frames in a row, then the changes can negatively affect image quality due to the lower frame update rate. In that case, the mode switching circuitry can instruct the display to switch to the fast update, low resolution mode in block 779 and send the frame to the display in block 780. In various implementations, I can vary according to the host's requirements. In some implementations, I can be 2, 5, 10, or 20 consecutive frames. Of course, other values of I are possible according to the host's requirements.

While the threshold I can be fixed by the host in some implementations, in other implementations, I can be a function of the amount of distributed change between frames. For example, in some instances, an image can change a great deal over only one or two frames. In such a situation, it is often desirable to switch to the fast update mode immediately (e.g. I equals 1 or 2) so that the user can better see the changes in the image over time. In this implementation, therefore, I can be lowered when the distributed changes between the incoming frames are substantially high, e.g., if the distributed changes exceed a threshold of being a substantially high distributed change. For example, if the distributed changes in an image exceed a certain threshold (as one example, 40%, 50%, 60%, 70%, etc., of the area of an image), then I can be a lower number of frames, such as 1 or 2 frames, or any other suitably small number of frames. Conversely, if the amount of distributed changes is fairly small (e.g., only about 1%, 5%, 10%, etc. of the image area changes from frame to frame), then I can be raised to require a higher number of frames (e.g., 5, 7, or 10 frames) of distributed changes before switching to the fast update mode.

Once the display is set to the fast update, low resolution mode of block 781, it can receive incoming frames and determine whether there are changed image regions in the incoming frame as compared to other consecutive frames in block 782. If there are changed image regions, then the method can transition to block 794, in which circuitry can determine whether the changed image regions are distributed across the display (for example, if a video occupying a large portion of the display is playing over several consecutive frames). If there are distributed changes, then it can be desirable to remain in the low resolution mode, as explained above. Thus, in block 783, the frame can be sent to the display and the display can remain in fast update, low resolution mode according to block 781.

If, however, there are no detected changed image regions or no detected distributed change between frames in blocks 782 and 794, then the method can transition to block 784, in which the mode switching circuitry can determine whether the absence of changed image regions or distributed changes occurs over J frames in a row. If not, then the frame can be sent to the display in block 783, and the display can again remain in fast update, low resolution mode in block 781. As an example of this scenario, if the user is watching video and a particular scene in the video does not include any movement, then it may still be desirable to keep the display in fast update mode in order to ensure that the visible flow of the video is maintained at a high quality for viewing. In various implementations, J can vary according to the host's requirements and may be different than, or the same as, I. In some implementations, J can be 2, 5, 10, or 20 consecutive frames. Of course, other values of J are possible according to the host's requirements.

Similar to the threshold I above with respect to block 778, J can also vary according to the amount of distributed changes from frame to frame, e.g., a summation of the distributed changes over a series of frames. For example, if the amount of any distributed changes are very low, then a smaller number of frames can be used as the threshold J, while if there are at least some distributed changes, then the host may choose to use a higher number of frames as the threshold J to ensure that the slow update mode is appropriate for that series of frames.

If more than J frames in a row do not experience distributed changes in block 784, then it can be desirable to again switch to the slow update, high resolution mode in block 785 and send the frame to the display in block 786. The process can then repeat at block 775, e.g., when the display is set to the slow update, high resolution mode.

FIG. 16B is a flowchart generally similar to the flowchart of FIG. 16A. Reference numerals and blocks similar to those in FIG. 16A can generally represent similar processes or decisions. One difference, however, is that if changed image regions are detected in block 776, block 787 illustrates one way to determine if the changed image regions are distributed or localized/concentrated. In some implementations, the changed image regions can form a moving area in the display (see, e.g., moving areas 744′, 746′, 748′ of FIG. 17C, which are discussed in more detail below). In some implementations, the moving area can include many changed image regions that are substantially contiguous or that are otherwise bounded. For example, if a rectangular video window is opened in a portion of the display, then the area formed by the video window can be a moving area, because there are likely to be many substantially contiguous (or otherwise bounded) changed image regions within the video window from frame to frame. If the moving area exceeds a certain area of the display, then the changed image regions can be considered sufficiently widespread or scattered such that the low resolution (fast update) mode can be selected.

In other implementations, the total area of the changed image regions can be considered. For example, if many changed image regions are spread throughout the display (e.g., not bounded or contiguous), and if the cumulative area of those changed image regions exceeds a threshold, then these changed image regions are also scattered or widely distributed. In these implementations, the contiguity or connectedness of the changed image regions can be less important than the total area of the changed image regions. Thus, in various implementations, the moving area can be defined by a contiguous or bounded area of changed image regions, or the moving area can be the total cumulative area of the changed image regions.

As illustrated in FIG. 16C, one threshold area 791 of the display can be represented by a rectangle or square in some implementations. As shown in FIG. 16C, the threshold area 791 can have an area of K*L, where K and L can be a number of pixels, display elements, or other suitable unit representative of length on a display (e.g., millimeters). In other implementations, the image area 791 can take on any other suitable shape, such as, e.g., a circle, oval, or any other type of polygon or shape. The total area of the threshold area 791 can vary according to various implementations. Any suitable threshold percentage of the image area can be used; for example, in some implementations, the threshold percentage can be 5%, 10%, 20%, 30%, or 40% of the total area of the image.

Furthermore, the threshold area 791 can be defined in any portion of the display. In some implementations, the threshold area 791 can be confined to a single quadrant, in which case the total area of the threshold area 791 can be used in decision block 787. Alternatively, the threshold area 791 can span or overlap two or more quadrants or divisions of the display (see, e.g., FIG. 16E and the discussion thereof below). For example, a particular threshold area 791 can span or overlap two, three, or four quadrants of the display. In some implementations, the threshold area 791 can vary according to the number of quadrants the threshold area 791 spans or overlaps. For example, in various implementations, the threshold area 791 may be smaller if the threshold area 791 spans or overlaps a large number of quadrants, e.g., 3 or 4 quadrants. Similarly, the threshold area 791 may be larger if the threshold area 791 spans or overlaps a small number of quadrants, e.g., 1 or 2 quadrants.

Returning to block 787 of FIG. 16B, if the moving area (e.g., the cumulative moving area of changed image regions, or the bounded/contiguous moving area) is less than a threshold area (e.g., the threshold area K*L of FIG. 16C, or other suitable threshold area), then the changed image regions can be considered sufficiently localized or concentrated, and the frame can be sent in block 777 to the display. The display can then remain in high resolution (slow update) mode in block 775. If, however, the moving area exceeds the threshold area, then, as above, processing circuitry can determine whether the moving area exceeds the threshold area for a predetermined number of frames in block 778. If the moving area exceeds the threshold area for I frames in a row, then the display can be switched to the low resolution mode in block 779.

Similarly, if changed image regions are detected in block 782, then circuitry can determine whether the moving area is greater than the threshold area 791 in block 788. If so, then the changed image regions are likely still distributed or scattered, and the frame can be sent to the display in block 783. The display can thus remain in the low resolution mode in block 781. If, however, the moving area does not exceed the threshold area 791 in block 788, then circuitry can determine whether the moving area is less than the threshold area for J frames in a row. The rest of the process can continue as described above with respect to FIG. 16A.

Turning to FIG. 16D, another implementation is disclosed. FIG. 16D is generally similar to FIG. 16B, except block 789 illustrates another way to determine whether the changed image regions of block 776 are scattered or localized/concentrated. In block 789, if the moving area(s) span at least part of two different image quadrants, then the changed image regions can be considered scattered or widely distributed and the low resolution mode can be selected. FIG. 16E illustrates one example of a segmented frame 792 that is divided into four quadrants: Q₁, Q₂, Q₃, and Q₄. As an example, if the moving area detected in block 776 spans any two different quadrants Qₓ and Q_{y}, (e.g., spanning Q₁ and Q₄, or spanning Q₂ and Q₃), then in some implementations, the changed image regions can be considered scattered. In other implementations there may be multiple moving areas (e.g., if there are, for example, multiple video windows). If the multiple moving areas are positioned in at least two different quadrants, then the changed image regions are scattered or diffuse.

The process can then proceed to block 778 as described above. On the other hand, if the moving area(s) or changed image regions are localized within one quadrant (e.g., within Q₄), then the high resolution mode can be selected, as described above. Similarly, block 790 tests whether the moving area(s) spans at least two different quadrants Qₓ and Q_{y}. If the moving area(s) span at least two different quadrants, then the display can remain in the low resolution mode by returning to block 781. Otherwise, the process can proceed to block 784 as described above.

In some implementations, both the threshold area and the quadrant location(s) of the moving area can be considered in combination when determining whether to select the high or low resolution modes. For example, if the changed image regions occur over a large area (e.g., exceeding K*L) but are still localized within one quadrant, then the low resolution mode can be selected notwithstanding the localization within a single quadrant. As another example, if the moving area(s) span more than one quadrant, but are localized within a small area (e.g., less than K*L in some implementations), then in some implementations the high resolution mode can be selected. Moreover, in some implementations, the moving area(s) must span at least 3 or 4 different quadrants for the distribution to be considered scattered. In other implementations, quadrants may not be used; instead, any other suitable segmentation of the display can be used, such as, e.g., dividing the display into 2, 3, 5, 6, 7, 8, or any other suitable number of segmentations.

FIGS. 17A-C schematically illustrate a frame having a grid of image regions at predefined coordinates according to one implementation. Turning to FIG. 17A, an example frame 740 may define a grid of n×m image regions 742 at predefined coordinates (x, y). Each image region 742 can include one or more pixels, with each pixel including one or more display elements, e.g., one or more interferometric MEMS display elements. As mentioned above, in some implementations, each pixel can include a 3×3 array of display elements (or 9 total display elements). As an example, in some implementations, such as in an XGA format, the display array can include a 1024×768 array of pixels. In this implementation, each image region 742 can include, as one example, a square of 32×32 pixels. If each pixel includes a 3×3 array of display elements, then each image region would include 1024 pixels and 9216 display elements in this implementation. Thus, for this example, n would be 32, and m would be 24, for 32×24 image regions 742.

Each incoming frame 740 can include a plurality of portions 744, 746, 748 representing portions of the image that may have different motion or change characteristics. As shown in FIG. 17A, each image portion (e.g., portions 744, 746, 748) can include one or more image regions 742.

Analysis of the image regions 742 can assist in determining whether the spatial distribution of changed image regions is concentrated or scattered. There are a variety of methods to determine whether or not the spatial distribution of changed image regions is concentrated or scattered. As described above, the distributed changes can be determined based on a threshold area of the display (e.g., FIGS. 16B and 16C), and/or based on the number of quadrants (or other segments) in which the changed image regions or moving area(s) lie (e.g., FIGS. 16D and E).

In other implementations, there can be additional methods for determining whether or not changed image regions are scattered or localized/concentrated. For instance, if there are N changed image regions, the host can use the coordinates of the changed image regions to calculate the distance between any pair of changed image regions. If two image regions are separated by a particular distance, (e.g., by 10%, 20%, 30%, 40%, 50%, 60%, or some other percentage of the width or height of the image, or by a certain number of pixels), then the pair can be considered substantially separated. If M pairs of the N changed image regions are substantially separated, then the spatial distribution can be considered scattered, and the low resolution mode can be selected. In other implementations, the spatial distribution of changed image regions can be considered concentrated if the changed image regions include image regions 742 or pixels that are substantially contiguous within each frame, while changed image regions (or pixels) that are not substantially contiguous can be considered scattered. For example, if a vertical line is introduced in an incoming frame, then the line can represent a concentrated spatial distribution (corresponding to selection of the high resolution mode) because the changed image regions will be substantially contiguous. The low resolution mode may be more suitable for abrupt introduction of vertical (or otherwise straight or rigid) objects, because the human eye can more easily perceive straight edges.

In the above example of viewing a video window on a small portion of a display while viewing text on the rest of the display, the image portions 744, 746, 748 of FIG. 17A represent a first frame 740 prior to opening the video window. Thus, the solid white portions 744, 746, 748 can represent text displayed on most of the screen in a high resolution mode. When the user opens the video window in portion 744 in the top left part of a second incoming frame 741, the image regions 742 within portion 744 change by a substantial amount (e.g., exceeding the threshold) to display the incoming video data, represented by slanted lines in FIG. 17B. Because the image regions 742 within portion 744 are changed image regions, portion 744 can be considered a moving area 744′ in some implementations.

However, because the video window is concentrated in only the top left quadrant, Q₁, of the second frame 741, e.g., within moving area 744′, the image regions 742 within portions 746, 748 do not undergo substantial changes, and thus the image regions 742 within moving area 744′ are the only changed image regions shown. Thus, in some implementations (e.g., FIG. 16D), the display can remain in the high resolution, low refresh rate mode, because the moving area 744′ is localized within a single quadrant. In other implementations, as described above, the moving area 744′ may not exceed the threshold area 791, and the display can remain in the high resolution mode for this reason as well. Note that in other implementations, however, if the area of moving area 744′ exceeds the threshold area 791, then the display may nevertheless be switched to the low resolution, high refresh rate mode.

In contrast, if the user instead views a movie or video game on a large portion of the screen, then many or most image regions 742 within image portions 744, 746, 748 may change by a substantial amount (e.g., over the threshold), as shown by slanted lines within all three portions in FIG. 17C. Because the image regions 742 within portions 744, 746, 748 are changed image regions, these portions can be considered moving areas 744′, 746′, 748′ in some implementations. In the implementation of FIG. 16B, for instance, if the area of any one of the moving areas 744′, 746′, 748′ exceeds the threshold area 791, then the changed image regions would be considered to be scattered. Thus, if, for example, moving area 746′ exceeds the threshold area 791, then the changed image regions are scattered. In other implementations, if the combined area of the moving areas 744′, 746′, 748′ (or the combined area of all changed image regions) exceeds the threshold area 791, then the changed image regions are scattered.

In the implementation of FIG. 16D, the changed image regions would also be scattered because moving areas 746′ and 748′ span two different quadrants, e.g., Q2 and Q4, and Q3 and Q4, respectively. In other implementations, because the moving areas 744′, 746′, and 748′ are collectively positioned at least partially within four different quadrants, the changed image regions can be considered scattered. In yet other implementations, the changed image regions are scattered due to the combination of exceeding the threshold area and lying in multiple quadrants (or segments).

In other implementations as described above, the changed image regions can be considered substantially separated based on the distance between the changed image regions. For example, changed image regions within moving areas 744′ and 748′ may be considered substantially separated (in terms of their coordinates), changed image regions within moving areas 744′ and 746′ may be considered substantially separated, and changed image regions within moving areas 748′ and 746′ may also be considered substantially separated. If a sufficient number of pairs of changed image regions are substantially separated, then the changed image regions are scattered or diffuse. As discussed above, the area and/or quadrant location of one or more of the moving areas can also be considered in combination with the separation distance between the image regions.

Thus, because the changed image regions 742 within the image portions 744, 746, 748 are substantially scattered (or diffuse) across the frame, the display can be switched into low resolution (high refresh rate) mode.

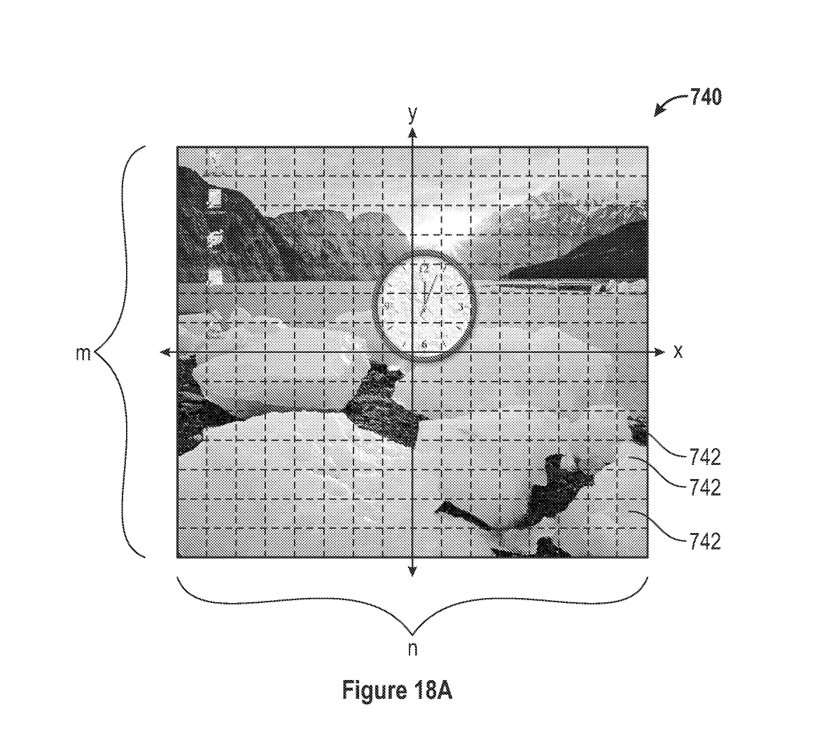

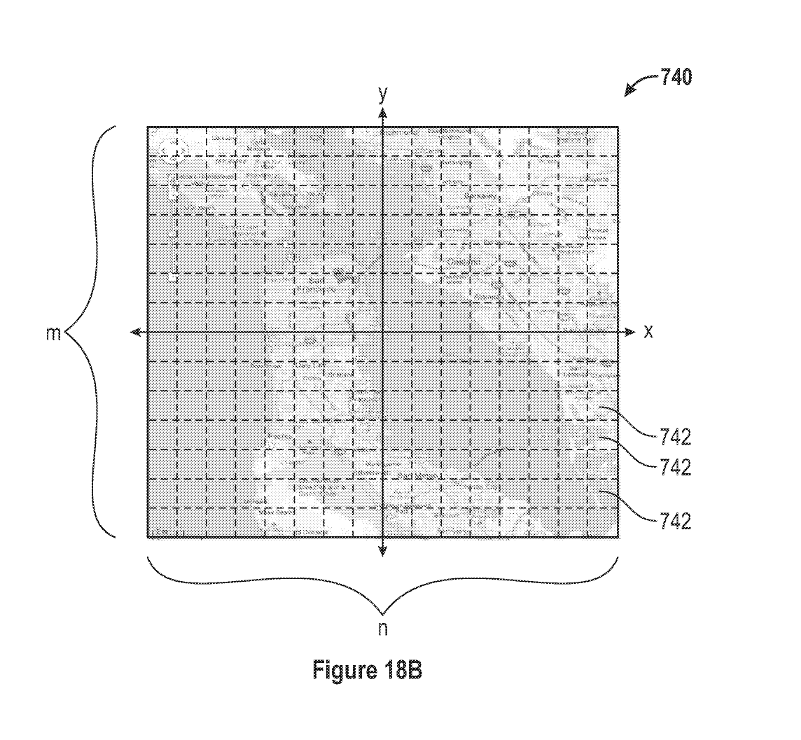

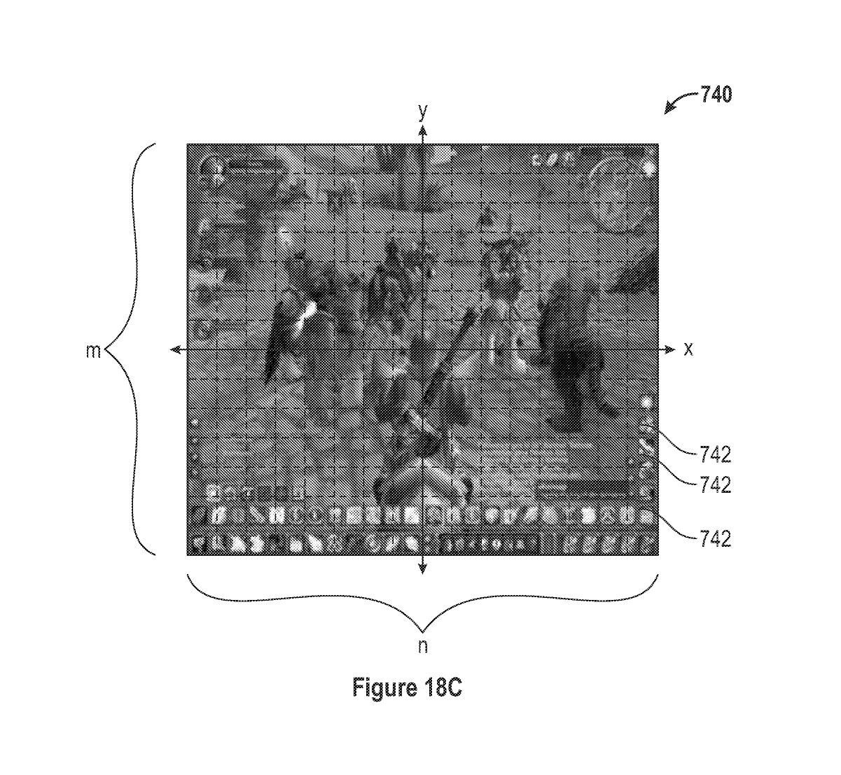

FIGS. 18A-C schematically illustrate example images that can be displayed according to some implementations. FIG. 18A illustrates an example of an image that can be viewed in a high resolution, slow update mode. In particular, FIG. 18A illustrates a high resolution desktop image having an analog desktop clock. The hands on the clock continually move, but the movement is very slow, and the movement occurs in only a small portion of the screen. Because the changes to the image over time are localized to a very small part of the screen, according to some implementations, the display may not switch to the low resolution, fast update mode. Given the small amount of movement, the user may not notice any visible problems with the high resolution mode.

Turning to FIG. 18B, a map is shown that can be viewed on a variety of displays. In this case, the user can zoom in to view a city in more detail, or the user can pan the map to see other locations. Depending on the amount of change between frames, the host can select either the high or low resolution mode. If, for instance, the user zooms in rapidly, the host may switch to low resolution mode to better illustrate the zooming motion. If, on the other hand, the user slowly pans the map to the left or right, for example, the host may determine that the changes are slow enough to remain in high resolution mode.

FIG. 18C illustrates an image taken of a video game, in which there is a great deal of movement across the entire image. If characters are constantly moving through the image, then it can be desirable to select the low resolution, fast update mode in order to provide the user with the best visual gaming experience. A skilled artisan will of course recognize that the examples of FIGS. 18A-C are merely illustrative and that many other scenarios are possible.

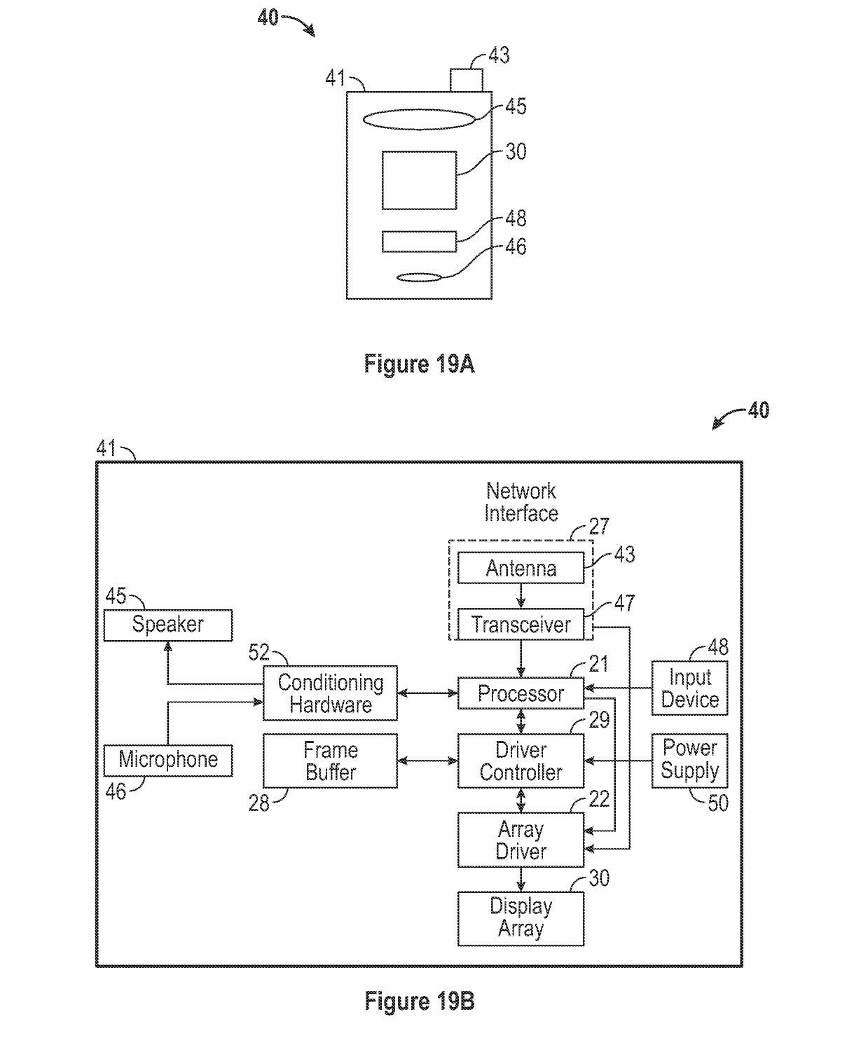

FIGS. 19A and 19B show examples of system block diagrams illustrating a display device 40 that includes a plurality of interferometric modulators. The display device 40 can be, for example, a cellular or mobile telephone. However, the same components of the display device 40 or slight variations thereof are also illustrative of various types of display devices such as televisions, e-readers, tablets, and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 19B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40, and may run the host software implementing the display mode control described above. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the claims are not intended to be limited to the implementations shown herein, but are to be accorded the widest scope consistent with this disclosure, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted can be incorporated in the example processes that are schematically illustrated. For example, one or more additional operations can be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. An apparatus, comprising:
a processor for driving a display including a plurality of common lines, the processor configured to:
obtain image data to be displayed for a plurality of frames, wherein the image data includes a plurality of image regions;
select a high resolution display mode or a low resolution display mode based at least in part on a spatial distribution of changed image regions over the plurality of frames; and,
update the display according to the selected display mode.

2. The apparatus of claim 1, wherein the processor is further configured to select the high resolution mode or the low resolution mode based at least in part on an amount of change of image data for the plurality of image regions over the plurality of frames.

3. The apparatus of claim 1, wherein the processor is configured to select the high resolution mode when the spatial distribution of changed image regions is substantially concentrated, and wherein the processor is configured to select the low resolution mode when the spatial distribution of changed image regions is substantially scattered.

4. The apparatus of claim 3, wherein an image region is a changed image region if the amount of change in image data over the plurality of frames for the image region exceeds a threshold.

5. The apparatus of claim 4, each frame including an array of pixels, wherein each image region includes a subset of the pixels, and wherein the processor is configured to determine whether the spatial distribution of changed image regions is substantially concentrated or substantially scattered based at least in part on the location within the array of changed image regions.

6. The apparatus of claim 5, wherein the spatial distribution of changed image regions is substantially concentrated if the changed image regions are substantially contiguous within each frame and include less than a threshold amount of the area of the frame.

7. The apparatus of claim 1, wherein the low resolution mode has a higher refresh rate than the high resolution mode.

8. The apparatus of claim 1, wherein the high resolution mode includes a single common line addressing mode, and wherein the low resolution mode includes a multiple common line addressing mode that determines how many common lines are to be written with the same data simultaneously.

9. The apparatus of claim 1, further comprising a memory device that is configured to communicate with the processor.

10. The apparatus as recited in claim 1, further comprising:
a driver circuit configured to send at least one signal to the display; and
a controller configured to send at least a portion of the data to the driver circuit.

11. The apparatus as recited in claim 1, further comprising:
an image source module configured to send the image data to the processor.

12. The apparatus as recited in claim 11, wherein the image source module includes at least one of a receiver, transceiver, and transmitter.

13. The apparatus as recited in claim 1, further comprising:
an input device configured to receive input data and to communicate the input data to the processor.

14. The apparatus as recited in claim 1, wherein the display comprises an interferometric modulator.

15. A method of updating a display, the method comprising:
obtaining image data to be displayed;
detecting an amount of change of image data for a plurality of image regions over a plurality of frames to be displayed;
comparing the amount of change for each image region to a threshold to determine whether each image region is a changed image region;
selecting a high resolution display mode or a low resolution display mode based at least in part on a spatial distribution of changed image regions over the plurality of frames; and
updating the display according to the selected display mode.

16. The method of claim 15, further comprising selecting the high resolution mode when the spatial distribution is determined to be substantially concentrated, and selecting the low resolution mode when the spatial distribution is determined to be substantially scattered.

17. The method of claim 16, wherein each frame includes an array of pixels, wherein each image region includes a subset of the pixels, and wherein the determination of whether the spatial distribution of changed image regions is substantially concentrated or substantially scattered is based at least in part on the location within the array of changed image regions.

18. The apparatus of claim 17, wherein the spatial distribution of changed image regions is substantially concentrated if the changed image regions are substantially contiguous within each frame and include less than a threshold amount of the area of the frame.

19. The method of claim 15, wherein the low resolution mode has a higher refresh rate than the high resolution mode.

20. The method of claim 15, the display having a plurality of common lines, wherein updating the display according to the high resolution mode includes selecting a single common line addressing mode, and wherein updating the display according to the low resolution mode includes selecting a multi-line addressing mode, wherein the multi-line addressing mode determines how many common lines are to be written with the same data simultaneously.

21. The method of claim 15, wherein the data to be displayed includes video data.

22. The method of claim 15, wherein the data to be displayed includes still images.

23. The method of claim 15, wherein the data to be displayed includes text.

24. The method of claim 15, wherein updating the display according to the selected mode includes only updating a portion of the display.

25. The method of claim 15, wherein the selected mode reduces power consumption.

26. The method of claim 15, wherein the display includes an array of interferometric modulators.

27. A system for selecting display modes in a display, the system comprising:
means for obtaining image data to be displayed;
means for detecting an amount of change of image data for a plurality of image regions over a plurality of frames to be displayed;
means for comparing the amount of change for each image region to a threshold to determine whether each image region is a changed image region;
means for selecting a high resolution display mode or a low resolution display mode based at least in part on a spatial distribution of changed image regions over the plurality of frames; and
means for updating the display according to the selected mode.

28. The system of claim 27, wherein the means for obtaining data to be displayed includes an input device.

29. The system of claim 27, wherein the means for selecting a display mode includes a processor.

30. The system of claim 27, wherein the means for updating the display according to the selected mode includes a common driver.

31. The system of claim 27, wherein the display includes an interferometric modulator.

32. A computer program product for processing data for a program configured to drive a display, the computer program product comprising:
a non-transitory computer-readable medium having stored thereon code for causing processing circuitry to:
obtain image data to be displayed for a plurality of frames;
select a high resolution display mode or a low resolution display mode based at least in part on a spatial distribution of changed image regions over the plurality of frames; and
update the display according to the selected display mode.

33. The computer program product of claim 32, wherein the non-transitory computer-readable medium further includes code for causing processing circuitry to select the display mode based at least in part on an amount of change of image data for a plurality of image regions over the plurality of frames.

34. The computer program product of claim 32, wherein the display includes an interferometric modulator.

35. A module for switching between high and low resolution modes in a display, the module including circuitry configured to:
switch a display mode of a display from a high resolution mode to a low resolution mode when image data for a plurality of successive frames substantially change in substantially distributed portions of the frames; and
switch the display mode of the display from the low resolution mode to the high resolution mode when image data for the plurality of successive frames does not substantially change or substantially changes in substantially localized portions of the frames.

36. The module of claim 35, wherein image data for a plurality of successive frames substantially changes if the area of changed image data over the plurality of successive frames exceeds a threshold area.

37. The module of claim 35, wherein substantially localized portions of the frames include substantially contiguous areas within each frame.
